(19) United States
(12) Patent Application Publication
(10) Pub. No.: US 2020/0283297 A1
(43) Pub. Date: Sep. 10, 2020

(54) METHOD FOR PRODUCING OLIGOSILANE

(71) Applicant: SHOWA DENKO K.K., Tokyo (JP)

(72) Inventors: Kiyoshi NOMURA, Tokyo (JP); Hiroshi UCHIDA, Tokyo (JP); Yoshimitsu ISHIHARA, Tsukuba-shi, Ibaraki (JP); Shigeru SHIMADA, Tsukuba-shi, Ibaraki (JP); Kazuhiko SATO, Tsukuba-shi, Ibaraki (JP); Masayasu IGARASHI, Tsukuba-shi, Ibaraki (JP)

(73) Assignee: SHOWA DENKO K.K., Tokyo (JP)

(21) Appl. No.: 15/998,663

(22) PCT Filed: Feb. 14, 2017
(86) PCT No.: PCT/JP2017/005240

§ 371 Date: Aug. 16, 2018

(30) Foreign Application Priority Data
Feb. 16, 2016 (JP) 2016-026827
Nov. 21, 2016 (JP) 2016-225853

(51) Int. Cl. C01B 33/04; B01J 35/10; B01J 35/08; B01J 21/04; B01J 29/16; B01J 29/48; B01J 29/40; B01J 29/78; B01J 29/26; B01J 29/69; B01J 37/00; B01J 37/08

(52) U.S. Cl. CPC C01B 33/04; B01J 35/1057; B01J 35/08; B01J 21/04; B01J 29/166; B01J 29/48; B01J 2229/20; B01J 29/7815; B01J 29/26; B01J 29/69; B01J 29/78; B01J 37/0018; B01J 37/088; B01J 29/405

(57) ABSTRACT

A method for producing an oligosilane which includes a reaction step of producing an oligosilane by dehydrogenative coupling of hydrosilane. The reaction step is carried out in the presence of a catalyst containing at least one transition element selected from the group consisting of Periodic Table group 3 transition elements, group 4 transition elements, group 5 transition elements, group 6 transition elements, and group 7 transition elements. Also disclosed is a method for producing a catalyst for dehydrogenative coupling that produces an oligosilane by dehydrogenative coupling of hydrosilane.

### TECHNICAL FIELD

The present invention relates to a method for producing oligosilane and more particularly relates to a method for producing an oligosilane by dehydrogenative coupling of hydrosilane.

### BACKGROUND ART

Disilane, which is a typical oligosilane, is a useful compound that can be used as, for example, precursors for the formation of silicon films.

The following methods for producing oligosilanes, for example, have been reported: the acid decomposition of magnesium silicide (refer to Non-Patent Document 1), the reduction of hexachlorodisilane (refer to Non-Patent Document 2), electric discharge in monosilane (refer to Patent Document 1), the thermal decomposition of silane (refer to Patent Documents 2 to 4), and the dehydrogenative coupling of silane using a catalyst (refer to Patent Documents 5 to 10).

### PRIOR ART DOCUMENT

### Patent Document

Patent Document 1: U.S. Pat. No. 5,478,453 (Specification)
Patent Document 2: Japanese Patent No. 4855462
Patent Document 3: Japanese Patent Application Laid-open No. H11-260729
Patent Document 4: Japanese Patent Application Laid-open No. H03-183614
Patent Document 5: Japanese Patent Application Laid-open No. H01-198631
Patent Document 6: Japanese Patent Application Laid-open No. H02-184513
Patent Document 7: Japanese Patent Application Laid-open No. H05-032785
Patent Document 8: Japanese Patent Application Laid-open No. H03-183613
Patent Document 9: Japanese Translation of PCT Application No. 2013-506541
Patent Document 10: WO2015/060189

### Non-Patent Document

Non-Patent Document 1: Hydrogen Compounds of Silicon. I. The Preparation of Mono- and Disilane, WARREN C. JOHNSON and SAMPSON ISENBERG, J. Am. Chem. Soc., 1935, 57, 1349.
Non-Patent Document 2: The Preparation and Some Properties of Hydrides of Elements of the Fourth Group of the Periodic System and of their Organic Derivatives, A. E. FINHOLT, A. C. BOND Jr., K. E. WILZBACH and H. I. SCHLESINGER, J. Am. Chem. Soc., 1947, 69, 2692.

### SUMMARY OF INVENTION

### Problem to be Solved by Invention

The acid decomposition of magnesium silicide, reduction of hexachlorodisilane, and electric discharge in monosilane reported as oligosilane production methods generally have tended to readily impose high production costs. There has also been room for improvement with, for example, the thermal decomposition of silane and dehydrogenative coupling of silane using a catalyst, with regard to the selective synthesis of a particular oligosilane, e.g., disilane.

An object of the present invention is to provide an oligosilane production method that uses a specific catalyst, i.e., to provide a method that can produce an oligosilane at higher yield than without the use of a catalyst.

### Solution to Problem

As a result of intensive and extensive investigations directed to solving the problem indicated above, the present inventors found out that oligosilane can be efficiently produced by carrying out the dehydrogenative coupling reaction of hydrosilanes in the presence of a catalyst that contains at least one transition element selected from the group consisting of Periodic Table group 3 transition elements, group 4 transition elements, group 5 transition elements, group 6 transition elements, and group 7 transition elements. The present invention was achieved based on this finding.

That is, the present invention is as follows.

<1> A method for producing an oligosilane, including a reaction step of producing an oligosilane by dehydrogenative coupling of hydrosilane, wherein the reaction step is carried out in the presence of a catalyst containing at least one transition element selected from the group consisting of Periodic Table group 3 transition elements, group 4 transition elements, group 5 transition elements, group 6 transition elements, and group 7 transition elements.

<2> The method for producing an oligosilane according to <1>, wherein the catalyst is a heterogeneous catalyst containing a support and contains the transition element on the surface and/or in the interior of the support.

<3> The method for producing an oligosilane according to <2>, wherein the support is at least one selected from the group consisting of silica, alumina, titania, and zeolite.

<4> The method for producing an oligosilane according to <3>, wherein the zeolite has pores with a minor diameter of at least 0.43 nm and a major diameter of not more than 0.69 nm.

<5> The method for producing an oligosilane according to <3>, wherein the support is a spherical or cylindrical molding of an alumina-containing powder as a binder and a zeolite having pores with a minor diameter of at least 0.43 nm and a major diameter of not more than 0.69 nm, and has an alumina content (per 100 mass parts of the support not containing the alumina or transition element) of at least 10 mass parts and not more than 30 mass parts.

<6> The method for producing an oligosilane according to any of <1> to <5>, wherein the transition element is at least one transition element selected from the group consisting of titanium, vanadium, niobium, chromium, molybdenum, tungsten, and manganese.

<7> The method for producing an oligosilane according to <6>, wherein the transition element is at least one transition, element selected from the group consisting of molybdenum and tungsten.

<8> The method for producing an oligosilane according to any of <3> to <7>, wherein the catalyst contains zeolite as a support and further contains, on the surface and/or in the interior of the zeolite, at least one main group element selected from the group consisting of Periodic Table group 1 main group elements and group 2 main group elements.

<9> The method for producing an oligosilane according to <8>, wherein the overall transition element content and the overall main group element content (with respect to the zeolite in a state containing the transition element and main group element) are amounts that satisfy the condition in the following formula (1):

$$[ Math . 1 ]$$

$$0.1 ≦ \frac{AM \text{/} A 1}{1 - TM \text{/} A 1} ≦ 0.9 \qquad ( 1 )$$

(In formula (1), AM/Al represents an atomic ratio obtained by dividing the total number of main group element atoms contained in the zeolite by the number of aluminum atoms contained in the zeolite, and TM/Al represents an atomic ratio obtained by dividing the total number of transition element atoms contained in the zeolite by the number of aluminum atoms contained in the zeolite.).

<10> The method for producing an oligosilane according to <8> or <9>, wherein the overall main group element content (with respect to the mass of the zeolite in a state containing the transition element and main group element) is at least 2.1 mass % and not more than 10 mass %.

<11> A method for producing a catalyst for dehydrogenative coupling that produces an oligosilane by dehydrogenative coupling of hydrosilane, the catalyst containing, on the surface and/or in the interior of a support, at least one transition element selected from the group consisting of Periodic Table group 3 transition elements, group 4 transition elements, group 5 transition elements, group 6 transition elements, and group 7 transition elements, the catalyst production method characteristically containing:

a support preparation step of preparing a support;

a transition element introduction step of loading the support prepared in the support preparation step with at least one transition element selected from the group consisting of Periodic Table group 3 transition elements, group 4 transition elements, group 5 transition elements, group 6 transition elements, and group 7 transition elements; and a transition element heating step of heating a precursor that has gone through the transition element introduction step.

<12> The method for producing a catalyst according to <11>, wherein the catalyst further contains at least one main group element selected from the group consisting of Periodic Table group 1 main group elements and group 2 main group elements, the method further including:

a main group element introduction step of loading the support with at least one main group element selected from the group consisting of Periodic Table group 1 main group elements and group 2 main group elements.

<13> The method for producing a catalyst according to <12>, including:

a main group element heating step of heating a precursor that has gone through the main group element introduction step.

<14> The method for producing a catalyst according to <13>, wherein the main group element introduction step, main group element heating step, transition element introduction step, and transition element heating step are carried out in this order.

<15> The method for producing a catalyst according to <13>, wherein the transition element introduction step, transition element heating step, main group element introduction step, and main group element heating step are carried out in this order.

<16> The method for producing a catalyst according to any of <11> to <15>, wherein the support is at least one selected from the group consisting of silica, alumina, titania, and zeolite.

<17> The method for producing a catalyst according to <16>, wherein the zeolite has pores with a minor diameter of at least 0.43 nm and a major diameter of not more than 0.69 nm.

<18> The method for producing a catalyst according to <16>, wherein the support is a spherical or cylindrical molding of an alumina-containing powder as a binder and a zeolite having pores with a minor diameter of at least 0.43 nm and a major diameter of not more than 0.69 nm, and has an alumina content (per 100 mass parts of the support not containing the alumina or transition element) of at least 10 mass parts and not more than 30 mass parts.

<19> The method for producing a catalyst according to any of <11> to <18>, wherein the transition element is at least one transition element selected from the group consisting of titanium, vanadium, niobium, chromium, molybdenum, tungsten, and manganese.

<20> The method for producing a catalyst according to any of <11> to <19>, wherein the transition element heating step is a step of heating to at least 600° C. and not more than 1,000° C.

<21> The method for producing a catalyst according to any of <13> and <15> to <20>, wherein the main group element heating step is a step of heating to at least 100° C. and not more than 1,000° C.

<22> The method for producing a catalyst according to any of <19> to <21>, wherein the transition element is at least one transition element selected from the group consisting of molybdenum and tungsten.

<23> A catalyst for dehydrogenative coupling that produces an oligosilane by dehydrogenative coupling of hydrosilane, wherein the catalyst characteristically contains at least one transition element selected from the group consisting of Periodic Table group 3 transition elements, group 4 transition elements, group 5 transition elements, group 6 transition elements, and group 7 transition elements.

<24> The catalyst according to <23>, that is a heterogeneous catalyst containing a support and contains the transition element on the surface and/or in the interior of the support.

<25> The catalyst according to <24>, wherein the support is at least one selected from the group consisting of silica, alumina, titania, and zeolite.

<26> The catalyst according to <25>, wherein the zeolite has pores with a minor diameter of at least 0.43 nm and a major diameter of not more than 0.69 nm.

<27> The catalyst according to <25>, wherein the support is a spherical or cylindrical molding of an alumina-containing powder as a binder and a zeolite having pores with a minor diameter of at least 0.43 nm and a major diameter of not more than 0.69 nm, and has an alumina content (per 100 mass parts of the support not containing the alumina or transition element) of at least 10 mass parts and not more than 30 mass parts.

<28> The catalyst according to any of <23> to <27>, wherein the transition element is at least one transition element selected from the group consisting of titanium, vanadium, niobium, chromium, molybdenum, tungsten, and manganese.

<29> The catalyst according to <28>, wherein the transition element is at least one transition element selected from the group consisting of molybdenum and tungsten.

<30> The catalyst according to any of <25> to <29>, wherein the catalyst contains zeolite as a support and further contains, on the surface of the zeolite and/or in its interior, at least one main group element selected from the group consisting of Periodic Table group 1 main group elements and group 2 main group elements.

<31> The catalyst according to <30>, wherein the overall transition element content and the overall main group element content (with respect to the zeolite in a state containing the transition element and main group element) are amounts that satisfy the condition in the following formula (1).

$$[ Math . 2 ]$$

$$0.1 ≦ \frac{AM \text{/} A 1}{1 - TM \text{/} A 1} ≦ 0.9 \qquad ( 1 )$$

(In formula (1), AM/Al represents an atomic ratio obtained by dividing the total number of main group element atoms contained in the zeolite by the number of aluminum atoms contained in the zeolite, and TM/Al represents an atomic ratio obtained by dividing the total number of transition element atoms contained in the zeolite by the number of aluminum atoms contained in the zeolite.)

<32> The catalyst according to <30> or <31>, wherein the overall main group element content (with respect to the mass of the zeolite in a state containing the transition element and main group element) is at least 2.1 mass % and not more than 10 mass %.

### Effect of the Invention

Oligosilanes can be efficiently produced in accordance with the present invention.

### BRIEF DESCRIPTION OF DRAWINGS

FIG. 1 is a schematic diagram of reactors that can be used in the oligosilane production method of the present invention ((a): batch reactor, (b): continuous tank reactor, (c): continuous tubular reactor).

FIG. 2 is a schematic diagram that shows reaction temperature profiles.

FIG. 3 is a schematic diagram of the reaction apparatus used in the examples and comparative examples.

### DESCRIPTION OF EMBODIMENTS

Specific examples will be described in the description of the details of the oligosilane production method of the present invention, but there is no limitation to the following content insofar as there is no departure from the essential features of the present invention and appropriate modifications can be made therein in the execution of the present invention.

<Oligosilane Production Method>

The oligosilane production method that is one aspect of the present invention (also abbreviated below as the “oligosilane production method”) is a production method that contains a reaction step in which an oligosilane is produced by dehydrogenative coupling of hydrosilane (also abbreviated below as the “reaction step”). The oligosilane production method is characterized in that this reaction step is carried out in the presence of a catalyst that contains at least one transition element selected from the group consisting of Periodic Table group 3 transition elements, group 4 transition elements, group 5 transition elements, group 6 transition elements, and group 7 transition elements (this is also abbreviated below as the “transition element”).

As a result of extensive investigations into a method for producing oligosilanes, the present inventors found out that oligosilanes can be efficiently produced by carrying out the dehydrogenative coupling reaction of hydrosilanes in the presence of a catalyst that contains the aforementioned transition element. While the effects of the transition element in this reaction are not entirely clear, it is thought that the transition element promotes the dehydrogenative coupling of hydrosilane resulting in production of the oligosilane at good efficiencies.

In the present invention, an “oligosilane” refers to the silane oligomers provided by the polymerization of a plurality (not more than 10) of individual (mono)silane molecules and specifically includes disilane, trisilanes, and tetrasilanes. Moreover, an “oligosilane” is not limited to only linear oligosilanes, but may be an oligosilane that has, for example, a branched structure, crosslinked structure, or cyclic structure.

In addition, a “hydrosilane” refers to a compound that has the silicon-hydrogen (Si—H) bond and specifically includes tetrahydrosilane (SiH₄). The “dehydrogenative coupling” of a hydrosilane refers to a reaction in which the silicon-silicon (Si—Si) bond is formed by hydrosilane-to-hydrosilane coupling with the elimination of hydrogen, as shown, for example, by the following reaction equation.

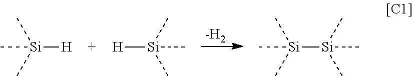

The “reaction step”, “catalyst”, and so forth are described in detail in the following.

The reaction step is characteristically carried out in the presence of a catalyst that contains at least one transition element selected from the group consisting of Periodic Table group 3 transition elements, group 4 transition elements, group 5 transition elements, group 6 transition elements, and group 7 transition elements (this catalyst is also abbreviated as the “catalyst” in the following), and the specific species of the “group 3 transition element”, “group 4 transition element”, “group 5 transition element”, “group 6 transition element”, and “group 7 transition element” are not particularly limited.

Examples of the group 3 transition elements include scandium (Sc), yttrium (Y), lanthanoid (La), and samarium (Sm) Examples of the group 4 transition elements include titanium (Ti), zirconium (Zr), and hafnium (Hf).

Examples of the group 5 transition elements include vanadium (V), niobium (Nb), and tantalum (Ta).

Examples of the group 6 transition elements include chromium (Cr), molybdenum (Mo), and tungsten (W).

Examples of the group 7 transition elements include manganese (Mn), technetium (Tc), and rhenium (Re).

The transition elements more preferred for use in the present invention are the group 4 transition elements, group 5 transition elements, group 6 transition elements, and group 7 transition elements. Specific examples thereof include titanium (Ti), vanadium (V), niobium (Nb), chromium (Cr), molybdenum (Mo), tungsten (W), and manganese (Mn).

The group 5 transition elements and group 6 transition elements are even more preferred for the transition element. Specific examples include vanadium (V), niobium (Nb), chromium (Cr), molybdenum (Mo), and tungsten (W).

Among the preceding, molybdenum (Mo) and tungsten (W) are particularly preferred for the transition element.

As long as the catalyst contains a transition element as described above, it may be a heterogeneous catalyst or a homogeneous catalyst; however, heterogeneous catalysts are preferred. The catalyst is particularly preferably a support-containing heterogeneous catalyst that contains the transition element on the surface and/or in the interior of the support.

The form and composition of the transition element in the catalyst are also not particularly limited, and, for example, in the case of a heterogeneous catalyst, the form may be that of a metal (metal simple substance, alloy) optionally having an oxidized surface or may be that of a metal oxide (a single metal oxide or a composite metal oxide). When the catalyst is a support-containing heterogeneous catalyst, for example, the metal and/or metal oxide may be supported at the surface of the support (outer surface and/or within the pores) or the transition element may be introduced into the interior of the support (support framework) by ion exchange or composite formation.

Examples of the homogeneous catalyst, on the other hand, include organometal complexes in which the central metal is a transition element.

Examples of the metal optionally having an oxidized surface include scandium, yttrium, lanthanoid, samarium, titanium, zirconium, hafnium, vanadium, niobium, tantalum, chromium, molybdenum, tungsten, manganese, technetium, and rhenium.

Examples of the metal oxide include scandium oxide, yttrium oxide, lanthanoid oxide, samarium oxide, titanium oxide, zirconium oxide, hafnium oxide, vanadium oxide, niobium oxide, tantalum oxide, chromium oxide, molybdenum oxide, tungsten oxide, manganese oxide, technetium oxide, and rhenium oxide, and their composite oxides.

The specific species of support is not particularly limited when the catalyst is a support-containing heterogeneous catalyst, and examples thereof include silica, alumina, titania, zirconia, silica-alumina, zeolite, active carbon, and aluminum phosphate, and among which, silica, alumina, titania, and zeolite are more preferred. Among these, supporting the transition element on silica, alumina, or zeolite is preferred from the standpoint of the thermal stability, while zeolite is more preferred from the standpoint of the disilane selectivity and zeolite having pores with a minor diameter of at least 0.43 nm and a major diameter of not more than 0.69 nm is particularly preferred. It is thought that the pore space in the zeolite acts as a reaction field for dehydrogenative coupling, and it is thought that a pore size of “a minor diameter of at least 0.43 nm and a major diameter of not more than 0.69 nm” is optimal for suppressing excessive polymerization and bringing about an improved selectivity for oligosilanes.

“Zeolite having pores with a minor diameter of at least 0.43 nm and a major diameter of not more than 0.69 nm” does not mean only zeolites that actually have “pores with a minor diameter of at least 0.43 nm and a major diameter of not more than 0.69 nm”, but also includes zeolites for which the pore “minor diameter” and “major diameter” as theoretically calculated from the crystalline structure respectively satisfy the aforementioned conditions. For the pore “minor diameter” and “major diameter”, reference can be made to “ATLAS OF ZEOLITE FRAMEWORK TYPES, Ch. Baerlocher, L. B. McCusker and D. H. Olson, Sixth Revised Edition 2007, published on behalf of the Structure Commission of the international Zeolite Association”. The minor diameter for the zeolite is at least 0.43 nm and is preferably at least 0.45 nm and is particularly preferably at least 0.47 nm.

The major diameter for the zeolite is not more than 0.69 nm and is preferably not more than 0.65 nm and is particularly preferably not more than 0.60 nm.

When the pore diameter of the zeolite is constant because, for example, the cross-sectional structure of the pore is circular, the pore diameter is then regarded as “at least 0.43 nm and not more than 0.69 nm”.

When the zeolite has a plurality of pore diameters, then the pore diameter of at least one type of pore should be “at least 0.43 nm and not more than 0.69 nm”.

The specific zeolite is preferably a zeolite having a framework type code, as provided in the database of the International Zeolite Association, corresponding to the following: AFR, AFY, ATO, BEA, BOG, BPH, CAN, CON, DFO, EON, EZT, FER, GON, IMF, ISV, ITH, IWR, IWV, IWW, MEI, MEL, MFI, OBW, MOR, MOZ, MSE, MTT, MTW, NES, OFF, OSI, PON, SFF, SFG, STI, STF, TER, TON, TUN, USI, and VET.

Zeolites with framework type codes corresponding to the following are more preferred: ATO, BEA, BOG, CAN, FER, IMF, ITH, IWR, IWW, MEL, MFI, OBW, MOR, MSE, MTW, NES, OSI, PON, SFF, SFG, STF, STI, TER, TON, TUN, and VET.

Zeolites with framework type codes corresponding to BEA, MFI, TON, MOR, and FER are particularly preferred.

Examples of zeolites with a framework type code corresponding to BEA include *Beta (beta), [B—Si—O]-*BEA, [Ga—Si—O]-*BEA, [Ti—Si—O]-*BEA, Al-rich beta, CIT-6, Tschernichite, and pure silica beta (the * indicates a mixed crystal of three polytypes with similar structures).

Examples of zeolites with a framework type code corresponding to MFI include *ZSM-5, [As—Si—O]-MFI, [Fe—Si—O]-MFI, [Ga—Si—O]-MFI, AMS-1B, AZ-1, Bor-C, Boralite C, Encilite, FZ-1, LZ-105, Monoclinic H-ZSM-5, Mutinaite, NU-4, NU-5, Silicalite, TS-1, TSZ, TSZ-III, TZ-01, USC 4, USI-108, ZBH, ZKQ-1B, ZMQ-TB, and organic-free ZSM-5.

Examples of zeolites with a framework type code corresponding to TON include *Theta-1, ISI-1, KZ-2, NU-10, and ZSM-22.

Examples of zeolites with a framework type code corresponding to MOR include mordenite.

Examples of zeolites with a framework type code corresponding to FER include ferrierite.

Zeolites ZSM-5, beta, ZSM-22, MOR, and FER are particularly preferred.

The silica/alumina ratio (mol/mol ratio) is preferably 5 to 10,000, more preferably 10 to 2,000, and particularly preferably 20 to 1,000.

When the catalyst is a support-containing heterogeneous catalyst, the overall transition element content in the catalyst (with reference to the mass of the support in a state containing the transition element, the main group element described below, and so forth) is preferably at least 0.01 mass %, more preferably at least 0.1 mass %, and still more preferably at least 0.5 mass % and is preferably not more than 50 mass %, more preferably not more than 20 mass %, and still more preferably not more than 10 mass %. If within the indicated range, oligosilane production can be carried out more efficiently.

When the catalyst is a support-containing heterogeneous catalyst, the catalyst preferably has the form of a molding provided by molding a powder into, for example, a spherical shape, cylindrical shape (pellet shape), ring shape, and honeycomb shape. A binder, e.g., alumina and a clay compound, may be used in order to mold the powder. The strength of the molding cannot be maintained when the amount of binder use is too small; when the amount of binder use is too large, this has a negative effect on the catalytic activity. As a consequence, when alumina is used as the binder, the alumina content (per 100 mass parts of the support (in the original powder form) not containing the alumina, transition element, or main group element, infra) is preferably at least 2 mass parts, more preferably at least 5 mass parts, and still more preferably at least 10 mass parts and is preferably not more than 50 mass parts, more preferably not more than 40 mass parts, and still more preferably not more than 30 mass parts. Within the indicated range, negative effects on the catalytic activity can be suppressed while the strength of the support is maintained.

Examples of the methods of loading the support with the transition element include impregnation and ion-exchange, which use a precursor in solution form, and a method in which a precursor is volatilized by, for example, sublimation, and vapor deposited on the support. Impregnation method is a method in which the support is brought into contact with a solution in which a transition element-containing compound is dissolved and the transition element-containing compound is thereby adsorbed to the surface of the support. Pure water is ordinarily used for the solvent, but organic solvents, e.g., methanol, ethanol, acetic acid, and dimethylformamide, may also be used as long as they dissolve the transition element-containing compound. Ion-exchange method is a method in which a support having acid sites, e.g., zeolite, is brought into contact with a solution in which an ion of the transition element is dissolved, thereby introducing the transition element ion at the acid sites on the support. Pure water is again ordinarily used as the solvent in this case, but organic solvents, e.g., methanol, ethanol, acetic acid, and dimethylformamide, may also be used as long as they dissolve the transition element. Vapor deposition method is a method in which the transition element itself or the transition element oxide is heated in order to volatilize same by, e.g., sublimation, and thereby bring about its vapor deposition on the support. After the execution of an impregnation, ion-exchange, vapor deposition method, or the like, preparation of the metal or metal oxide form desired for the catalyst can be carried out by the execution of treatments such as drying, and calcination in a reducing atmosphere or an oxidizing atmosphere.

In the case of molybdenum, examples of the precursor for the transition element include ammonium heptamolybdate, silicomolybdic acid, phosphomolybdic acid, molybdenum chloride, and molybdenum oxide. In the case of tungsten, examples of the precursor for the transition element include ammonium paratungstate, phosphotungstic acid, silicotungstic acid, and tungsten chloride. In the case of titanium, examples of the precursor for the transition element include titanium oxysulfate, titanium chloride, and tetraethoxytitanium. In the case of vanadium, examples of the precursor for the transition element include vanadium oxysulfate, vanadium oxyoxalate, vanadium chloride, vanadium oxytrichloride, and bis(acetylacetonato)oxovanadium(IV). In the case of chromium, examples of the precursor for the transition element include ammonium chromate, chromium(III) acetylacetonate, and chromium(III) pyridine-2-carboxylate. In the case of niobium, examples of the precursor for the transition element include niobium oxalate and niobium ammonium oxalate. In the case of manganese, examples of the precursor for the transition element include manganese chloride, manganese(II) acetylacetonate, and manganese(III) acetylacetonate.

When the catalyst is a heterogeneous catalyst, it preferably contains at least one main group element (also abbreviated in the following as “main group element”) selected from the group consisting of Periodic Table group 1 main group elements and group 2 main group elements. The form and composition of the main group element in the catalyst is not particularly limited, but examples of the form include the metal oxide (single metal oxide, composite metal oxide) and the ion. In addition, when the catalyst is a support-containing heterogeneous catalyst, for example, the main group element may be supported in the form of the metal oxide or metal salt at the surface of the support (outer surface and/or within the pores) or the main group element may be introduced into the interior (support framework) by ion exchange or composite formation. The incorporation of such a main group element restrains the initial silane conversion and inhibits excessive consumption and in combination with this can raise the initial disilane selectivity. In addition, the catalyst life can also be extended by restraining the initial silane conversion.

Examples of the group 1 main group elements include lithium (Li), sodium (Na), potassium (K), rubidium (Rb), cesium (Cs), and francium (Fr).

Examples of the group 2 main group elements include beryllium (Be), magnesium (Mg), calcium (Ca), strontium (Sr), barium (Ba), and radium (Ra).

Among the preceding, the incorporation of sodium (Na), potassium (K), rubidium (Rb), cesium (Cs), francium (Fr), calcium (Ca), strontium (Sr), and barium (Ba) is preferred.

Impregnation method and ion-exchange method are examples of methods for incorporating the main group element in the catalyst when the catalysL is a support-containing heterogeneous catalyst. Impregnation method is a method in which the support is brought into contact with a solution in which a main group element-containing compound is dissolved and the main group element is thereby adsorbed to the surface of the support. Pure water is ordinarily used for the solvent, but organic solvents, e.g., methanol, ethanol, acetic acid, and dimethylformamide, can also be used as long as they dissolve the main group element-containing compound. Ion-exchange method is a method in which a support having acid sites, e.g., zeolite, is brought into contact with a solution provided by the dissolution of a compound from which the main group element can dissociate as the ion upon dissolution, to thereby introduce the main group element ion at the acid sites on the support. Pure water is also ordinarily used as the solvent in this case, but organic solvents, e.g., methanol, ethanol, acetic acid, and dimethylformamide, can also be used as long as they dissolve the main group element ion. Treatments such as drying and calcination may be carried out after the execution of an impregnation or ion-exchange method.

In the case of the incorporation of lithium (Li), examples of the solution include an aqueous lithium nitrate (LiNO₃) solution, an aqueous lithium chloride (LiCl) solution, an aqueous lithium sulfate (Li₂SO₄) solution, an aqueous lithium acetate (LiOCOCH₃) solution, an acetic acid solution of lithium acetate, and an ethanol solution of lithium acetate.

In the case of the incorporation of sodium (Na), examples of the solution include an aqueous sodium chloride (NaCl) solution, an aqueous sodium sulfate (Na₂SO₄) solution, an aqueous sodium nitrate (NaNO₃) solution, and an aqueous sodium acetate (NaOCOCH₃) solution.

In the case of the incorporation of potassium (K), examples of the solution include an aqueous potassium nitrate (KNO₃) solution, an aqueous potassium chloride (KCl) solution, an aqueous potassium sulfate (K₂SO₄) solution, an aqueous potassium acetate (KOCOCH₃) solution, an acetic acid solution of potassium acetate, and an ethanol solution of potassium acetate.

In the case of the incorporation of rubidium (Rb), examples of the solution include an aqueous rubidium chloride (RbCl) solution and an aqueous rubidium nitrate (KNO₃) solution.

In the case of the incorporation of cesium (Cs), examples of the solution include an aqueous cesium chloride (CsCL), an aqueous cesium nitrate (CsNO₃) solution, an aqueous cesium sulfate (Cs₂SO₄) solution, and an aqueous cesium acetate (CsOCOCH₃) solution.

In the case of the incorporation of francium (Fr), examples of the solution include an aqueous francium chloride (FrCl) solution.

In the case of the incorporation of calcium (Ca), examples of the solution include an aqueous calcium chloride (CaCl₂) solution and an aqueous calcium nitrate (Ca(NO₃)₂)

### Solution

In the case of the incorporation of strontium (Sr), examples of the solution include an aqueous strontium nitrate (Sr(NO₃)₂) solution.

In the case of the incorporation of barium (Ba), examples of the solution include an aqueous barium chloride (BaCl₂) solution, an aqueous barium nitrate (Ba(NO₃)₂) solution, and an aqueous barium acetate (Ba(OCOCH₃)₂) solution.

For the case of a heterogeneous catalyst in which the catalyst contains a support, the overall content of the main group element in the catalyst (with respect to the mass of the support in a state containing the transition element, main group element, and so forth) is preferably at least 0.01 mass %, more preferably at least 0.05 mass %, still more preferably at least 0.1 mass %, particularly preferably at least 0.5 mass %, more particularly preferably at least 1.0 mass %, and most preferably at least 2.1 mass %, and is preferably not more than 10 mass %, more preferably not more than 5 mass %, and still more preferably not more than 4 mass %. If within the indicated range, oligosilane production can be carried out more efficiently.

When the catalyst contains zeolite as the support and contains a transition element and main group element on the surface and/or in the interior of the zeolite, the overall transition element content and the overall main group element content (with respect to the zeolite in a state containing the transition element and main group element) are amounts that satisfy the condition in the following formula (1).

$$[ Math . 3 ]$$

$$0.1 ≦ \frac{AM \text{/} A 1}{1 - TM \text{/} A 1} ≦ 0.9 \qquad ( 1 )$$

(In formula (1), AM/Al represents the atomic ratio obtained by dividing the total number of main group element atoms contained in the zeolite by the number of aluminum atoms contained in the zeolite, and TM/Al represents the atomic ratio obtained by dividing the total number of transition element atoms contained in the zeolite by the number of aluminum atoms contained in the zeolite.)

The number of aluminum atoms contained in the zeolite correlates with the quantity of acid sites in the zeolite, and the value of “(AM/Al)/(1-TM/Al)” calculated therefrom makes it possible to assess the proportion of acid sites in the zeolite that are not ion-exchanged to an ion originating from the transition element, main group element, or the like. The values of “AM”, “TM”, and “Al” can be determined by, for example, complete dissolution of the catalyst with, for example, a strong acid, and analysis of this solution using inductively coupled plasma mass analysis (ICP-MASS). A more convenient method is to carry out determination from the amounts charged for the zeolite, main group element, and transition element.

The transition element is thought to express catalytic activity through its interaction with the acid sites of the zeolite. However, when the transition element is used in an amount in excess over the Al, not only is the activity expression effect absent, but the interaction with the Al is larger and the Al atoms in the zeolite then end up exiting the lattice. The transition element should thus be used in an equivalent range not exceeding the number of Al atoms (such that the denominator in the above formula does not become negative). On the other hand, the Al that does not interact with the transition element remains as acid sites and side reactions occur due to these acid sites, and this has a negative effect in particular on the initial reaction selectivity and the catalyst life. As a consequence, it is desirable that these acid sites be neutralized in advance.

When a main group element is used, the acid sites in the zeolite can be almost completely neutralized through ion exchange with the acid sites, and a portion is thus desirably neutralized in advance to a degree whereby these acid sites do not exercise an influence on the reaction. On the other hand, the activity ends up being reduced in the case of use in excess relative to the acid sites, and the use of an excessive amount is therefore desirably avoided.

The value of “(AM/Al)/(1-TM/Al)” is therefore preferably at least 0.1 and more preferably at least 0.2 and is preferably not more than 0.9 and more preferably not more than 0.8. Within this range, the acid sites in the zeolite remain present to a adequate degree and oligosilane production can then be carried out more efficiently.

When the catalyst is a heterogeneous catalyst, it may contain a Periodic Table group 13 main group element. There are no particular limitations on the form and composition of the Periodic Table group 13 main group element in the catalyst, and, for example, the form may be that of a metal (metal simple substance, alloy) optionally having an oxidized surface or may be that of a metal oxide (a single metal oxide or a composite metal oxide). When the catalyst is a support-containing heterogeneous catalyst, for example, the metal oxide may be supported at the surface of the support (outer surface and/or within the pores) or the Periodic Table group 13 main group element may be introduced into the interior (support framework) by ion exchange or composite formation. The incorporation of a Periodic Table group 13 main group element can also restrain the initial silane conversion and inhibit excessive consumption and in combination with this can raise the initial disilane selectivity. In addition, the catalyst life can also be extended by restraining the initial silane conversion.

Examples of the group 13 main group element include aluminum (Al), gallium (Ga), indium (In), and thallium (TI).

The method used to incorporate the Periodic Table group 13 main group element in the catalyst is the same as, for example, Periodic Table group 1 main group elements.

When the catalyst is a heterogeneous catalyst, the content of the Periodic Table group 13 main group element in the catalyst (with respect to the mass of the support in a state containing the aforementioned transition element, main group element, and Periodic Table group 13 main group element) is preferably at least 0.01 mass %, more preferably at least 0.05 mass %, still more preferably at least 0.1 mass %, particularly preferably at least 0.5 mass %, more particularly preferably at least 1.0 mass %, and most preferably at least 2.1 mass %, and is preferably not more than 10 mass %, more preferably not more than 5 mass %, and still more preferably not more than 4 mass %. If within the indicated range, oligosilane production can be carried out more efficiently.

The catalyst preferably satisfies the following condition (i), more preferably satisfies the following conditions (i) and (ii), still more preferably satisfies all of the following conditions (i) to (iii), and particularly preferably satisfies all of the following conditions (i) to (iv). Oligosilane production can be carried out at even better efficiencies when these conditions are satisfied. In addition, condition (v) is preferably satisfied from the standpoint of industrial implementation.

(i) The catalyst is a support-containing heterogeneous catalyst and contains a transition element on the surface and/or in the interior of the support.

(ii) The support is a zeolite having pores with a minor diameter of at least 0.43 nm and a major diameter of not more than 0.69 nm.

(iii) The catalyst is a support-containing heterogeneous catalyst and contains a main group element on the surface and/or in the interior of the support.

(iv) The overall transition element content and the overall main group element content (with respect to the zeolite in a state containing the transition element and main group element) are amounts that satisfy the condition in the following formula (1).

$$[ Math . 4 ]$$

$$0.1 ≦ \frac{AM \text{/} A 1}{1 - TM \text{/} A 1} ≦ 0.9 \qquad ( 1 )$$

(In formula (1), AM/Al represents the atomic ratio obtained by dividing the total number of main group element atoms contained in the zeolite by the number of aluminum atoms contained in the zeolite, and TM/Al represents the atomic ratio obtained by dividing the total number of transition element atoms contained in the zeolite by the number of aluminum atoms contained in the zeolite.)

(v) The catalyst is executed as a spherical or cylindrical molding of a powder-form support, and the alumina content is at least 10 mass % and not more than 30 mass %.

There are no particular limitations on the reactor, the operating procedure, the reaction conditions, and so forth used in the reaction step, and these may be selected as appropriate depending on the purpose. While the following describes specific examples of the reactor, operating procedure, reaction conditions, and so forth, there is no limitation to this content.

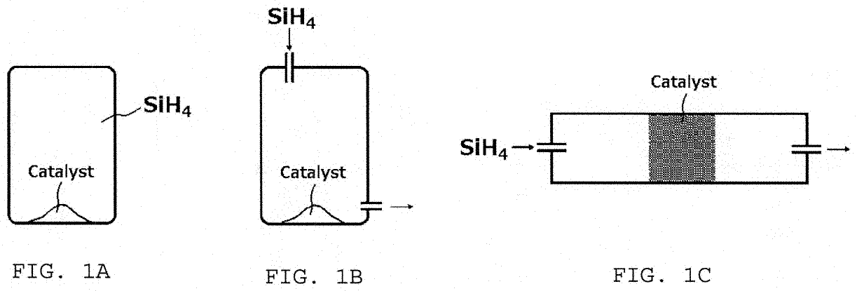

Any of the following types of reactors may be used for the reactor: a batch reactor as shown in FIG. 1(a), a continuous tank reactor as shown in FIG. 1(b), or a continuous tubular reactor as shown in FIG. 1(c).

The operating procedure when, for example, a batch reactor is used, can be exemplified by the following method: the dried zeolite according to the present invention is placed in the reactor; the air in the reactor is removed using, for example, a vacuum pump; the hydrosilane and so forth is then introduced and sealing is performed; and the reaction is started by raising the interior of the reactor to the reaction temperature.

When, on the other hand, a continuous tank reactor or a continuous tubular reactor is used, the operating procedure can be exemplified by the following method: the dried zeolite according to the present invention is placed in the reactor; the air in the reactor is removed using, for example, a vacuum pump; the hydrosilane and so forth is then caused to flow through; and the reaction is started by raising the interior of the reactor to the reaction temperature.

The reaction temperature is preferably at least 100° C., more preferably at least 150° C., and still more preferably at least 200° C., and is preferably not more than 450° C., more preferably not more than 400° C., and still more preferably not more than 350° C. If within the indicated range, oligosilane production can be carried out more efficiently.

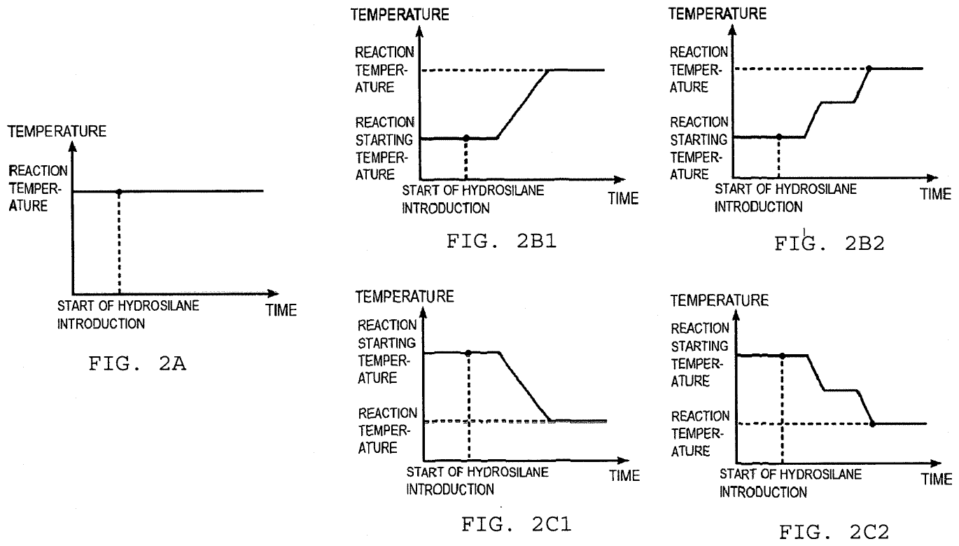

The reaction temperature may be as follows: it may be set at a constant level during the reaction step, as shown in FIG. 2(a); the reaction starting temperature may be set at a low value and the temperature may be raised during the reaction step, as shown in FIGS. 2(b1) and 2(b2); or the reaction starting temperature may be set at a high value and the temperature may be reduced during the reaction step, as shown in FIGS. 2(c1) and 2(c2) (the rise in the reaction temperature may be continuous as shown in FIG. 2(b1) or may be stepwise as shown in FIG. 2(b2); similarly, the reduction in the reaction temperature may be continuous as shown in FIG. 2(c1) or may be stepwise as shown in FIG. 2(c2)). In particular, preferably the reaction starting temperature is set at a low value and the reaction temperature is then raised during the reaction step. By setting a low reaction starting temperature, deterioration of the zeolite or the like can be suppressed and oligosilane production can then be carried out more efficiently. The reaction starting temperature when raising the reaction temperature is preferably at least 50° C., more preferably at least 100° C., and still more preferably at least 150° C., and is preferably not more than 350° C., more preferably not more than 300° C., and still more preferably not more than 250° C.

Compounds other than the zeolite according to the present invention and a hydrosilane may be introduced into or caused to flow through the reactor. Examples of the compounds other than the zeolite according to the present invention and a hydrosilane include gases such as hydrogen gas, helium gas, nitrogen gas, and argon gas and by solids that are almost completely unreactive with the hydrosilane, e.g., silica and titanium hydride, wherein execution in the presence of hydrogen gas is particularly preferred. When hydrogen gas is present, deterioration of the zeolite and so forth can be suppressed and oligosilane production can then be carried out in a stable manner on a long-term basis.

While the dehydrogenative coupling of hydrosilane produces disilane (Si₂H₆) as shown in reaction equation (i) below, it is thought that a portion of the produced disilane decomposes, as shown in reaction equation (ii) below, into tetrahydrosilane (SiH₄) and dihydrosilylene (SiH₂). It is also thought that this produced dihydrosilylene undergoes polymerization as shown in reaction equation (iii) below to form a solid polysilane (SiₙH₂ₙ) and that this polysilane adsorbs to the surface of the zeolite and the dehydrogenative coupling activity of the hydrosilane is then lowered and as a consequence the yield of the oligosilane, including disilane, is lowered.

When, on the other hand, hydrogen gas is present, it is thought that tetrahydrosilane is produced from dihydrosilylene as shown in reaction equation (iv) below and that the production of polysilane is then suppressed and as a consequence oligosilanes can be produced on a long-term and stable basis.

2SiH₄→Si₂H₆+H₂ (i)

Si₂H₆→SiH₄+SiH₂ (ii)

nSiH₂→SiₙH₂ₙ (iii)

SiH₂+H₂→SiH₄ (iv)

The reactor is preferably free of moisture to the greatest extent possible. For example, the zeolite and reactor are preferably thoroughly dried prior to the reaction.

The reaction pressure, considered as the absolute pressure, is preferably at least 0.1 MPa, more preferably at least 0.15 MPa, and still more preferably at least 0.2 MPa, and is preferably not more than 1,000 MPa, more preferably not more than 500 MPa, and still more preferably not more than 100 MPa. The hydrosilane partial pressure is preferably at least 0.0001 MPa, more preferably at least 0.0005 MPa, and even more preferably at least 0.001 MPa, and is preferably generally not more than 100 MPa, more preferably not more than 50 MPa, and still more preferably not more than 10 MPa. If within the indicated range, oligosilane production can be carried out more efficiently.

When the reaction step is carried out in the presence of hydrogen gas, the partial pressure of the hydrogen gas is preferably at least 0.01 MPa, more preferably at least 0.03 MPa, and still more preferably at least 0.05 MPa, and is preferably not more than 10 MPa, more preferably not more than 5 MPa, and still more preferably not more than 1 MPa. If within the indicated range, oligosilane production can be carried out in a long-term and stable manner.

With regard to the flow rate of the hydrosilane throughflow when a continuous tank reactor or a continuous tubular reactor is used, the conversion is too low at a short contact time with the catalyst while polysilane production is facilitated when the contact time with the catalyst is too long, and a contact time from 0.01 seconds to 30 minutes is preferable as a consequence. Considered per 1.0 g of zeolite according to the present invention, the flow rate set by the gas mass flow (amount converted to volume at the standard state (0° C., 1 atm) of tetrahydrosilane gas flowing through in 1 minute) is, preferably at least 0.01 mL/minute, more preferably at least 0.05 mL/minute, and still more preferably at least 0.1 mL/minute, and is preferably not more than 1,000 mL/minute, more preferably not more than 500 mL/minute, and still more preferably not more than 100 mL/minute. If within the indicated range, oligosilane production can be carried out more efficiently. In addition, when the reaction is carried out in a batch regime using, for example, an autoclave, polysilane production is facilitated when the reaction is run over a long period of time while the reaction conversion is too low at a too short period of time, and as a result a reaction time from 1 minute to 1 hour is preferable while from about 5 minutes to 30 minutes is more preferred.

With regard to the flow rate of the hydrogen gas throughflow when the reaction step is run in the presence of hydrogen gas, the flow rate set by the gas mass flow (amount converted to volume at the standard state (0° C., 1 atm) of tetrahydrosilane gas flowing through in 1 minute), per 1.0 g of zeolite according to the present invention, is preferably at least 0.01 mL/minute, more preferably at least 0.05 mL/minute, and still more preferably at least 0.1 mL/minute, and is preferably not more than 100 mL/minute, more preferably not more than 50 mL/minute, and still more preferably not more than 10 mL/minute. If within the indicated ranges, oligosilane production can be carried out in a long-term and stable manner.

<Catalyst>

While it is stated in the preceding that oligosilanes can be efficiently produced by carrying out the dehydrogenative coupling of hydrosilanes in the presence of a transition element as described above, an aspect of the present invention is also a catalyst for dehydrogenative coupling that produces oligosilanes by dehydrogenative coupling of hydrosilanes, wherein the catalyst characteristically contains at least one transition element selected from the group consisting of Periodic Table group 3 transition elements, group 4 transition elements, group 5 transition elements, group 6 transition elements, and group 7 transition elements.

The details of the catalyst are the same as described under <Oligosilane Production Method>, and hence such detailed description is omitted here.

<Catalyst Production Method>

It is stated in the preceding that a support-containing heterogeneous catalyst containing a transition element on the surface and/or in the interior of the support is a preferred catalyst for dehydrogenative coupling that produces an oligosilane by dehydrogenative coupling of hydrosilane, and an aspect of the present invention is also a catalyst production method that can produce this catalyst, i.e., a catalyst production method that characteristically includes the support preparation step, the transition element introduction step, and the transition element heating step described in the following (this is also abbreviated below as the “catalyst production method”).

Support preparation step: a step of preparing a support Transition element introduction step: a step of loading the support prepared in the support preparation step with at least one transition element selected from the group consisting of Periodic Table group 3 transition elements, group 4 transition elements, group 5 transition elements, group 6 transition elements, and group 7 transition elements

Transition element heating step: a step of heating a precursor that has gone through the transition element introduction step

The details of the produced catalyst are the same as described under <Oligosilane Production Method>, and hence such detailed description is omitted here.

The “support preparation step”, “transition element introduction step”, and “transition element heating step” are described in detail in the following.

There are no particular limitations on the specific method in the support preparation step as long as the support preparation step results in the preparation of the support used, and the support may be acquired or may itself be prepared.

Examples of the specific species of the support include silica, alumina, titania, zeolite, active carbon, and aluminum phosphate as described above; however, the support used is not limited to a single species and a combination of two or more species may be used.

The support may take the form of a molding provided by the molding of a powder into a spherical or cylindrical shape, and a binder, e.g., alumina and a clay compound, may be used in order to mold the powder. When alumina is used as the binder, the alumina content (per 100 mass parts of the support (in the original powder form) not containing the alumina, transition element, or main group element, infra) is preferably at least 2 mass parts, more preferably at least 5 mass parts, and still more preferably at least 10 mass parts and is preferably not more than 50 mass parts, more preferably not more than 40 mass parts, and still more preferably not more than 30 mass parts. Within the indicated range, negative effects on the catalytic activity can be suppressed while the strength of the support is maintained.

The transition element introduction step is a step of incorporating, in the support prepared in accordance with the support preparation step, at least one transition element selected from the group consisting of Periodic Table group 3 transition elements, group 4 transition elements, group 5 transition elements, group 6 transition elements, and group 7 transition elements; however, there are no particular limitations on the method for incorporating the transition element and a known method, e.g., an impregnation method, ion-exchange method, and vapor deposition method as described above, may be used as appropriate. A specific example is a method in which the support is brought into contact with an aqueous solution in which a transition element precursor compound is dissolved. The detailed conditions for this method for contacting the support with an aqueous solution are described in the following.

Examples of the precursor compound for the case of the incorporation of tungsten (W) include ammonium tungstate pentahydrate ((NH₄)₁₀W₁₂O₄₁.5H₂O), phosphotungstic acid, and silicotungstic acid.

Examples of the precursor compound for the case of the incorporation of vanadium (V) include vanadium oxysulfate (VOSO₄.nH₂O (n=3 and 4)) and vanadium oxyoxalate (V(C₂O₄)O.nH₂O).

Examples of the precursor compound for the case of the incorporation of molybdenum (Mo) include hexaammonium heptamolybdate tetrahydrate ((NH₄)₆Mo₇O₂₄.4H₂O), phosphomolybdic acid, and silicomolybdic acid.

Examples of the precursor compound for the case of the incorporation of chromium (Cr) include ammonium chromate ((NH₄)₂CrO₄), chromium(III) acetylacetonate, and chromium(III) pyridine-2-carboxylate.

Examples of the precursor compound for the case of the incorporation of niobium (Nb) include niobium ammonium oxalate ((NH₄) [Nb(O) (C₂O₄)₂(H₂O)₂]) and pentakis(hydrogen oxalate)niobium(V) (n hydrate) [Nb(HC₂O₄)₅.nH₂O)]. The concentration of the transition element precursor compound in the aqueous solution is preferably at least 0.01 mass %, more preferably at least 0.1 mass %, and still more preferably at least 0.5 mass % and is preferably generally not more than 30 mass %, more preferably not more than 10 mass %, and still more preferably not more than 5 mass %.

The temperature of the aqueous solution is preferably generally at least 5° C., more preferably at least 10° C., and still more preferably at least 15° C. and is preferably not more than 80° C., more preferably not more than 60° C., and still more preferably not more than 50° C.

The contact (impregnation) time between the support and aqueous solution is preferably at least 10 minutes, more preferably at least 30 minutes, and still more preferably at least 1 hour. Although, as the impregnation time is extended, a negative effect in correspondence thereto does not accrue, the impregnation time is preferably not more than 2 days, more preferably not more than 1 day, and still more preferably not more than 12 hours from the standpoint of the catalyst production efficiency.

The transition element heating step is a step of heating a precursor that has gone through the transition element introduction step, and a detail description follows for conditions such as the heating temperature.

The heating temperature in the transition element heating step can be set in the range from 500° C. to 1,100° C. depending on the temperature-resistance of the support used. It is preferably at least 600° C., more preferably at least 700° C., still more preferably at least 750° C., and particularly preferably at least 800° C. and is preferably not more than 1,100° C., more preferably not more than 1,000° C., and still more preferably not more than 950° C. The heating time after the prescribed temperature has been reached is preferably at least 30 minutes and within 24 hours and is more preferably at least 1 hour and within 12 hours. A catalyst with a higher level of activity can be produced within this range.

The heating temperature in the transition element heating step when the support is a zeolite is preferably at least 500° C., more preferably at least 600° C., and still more preferably at least 700° C. and is preferably not more than 1,000° C., more preferably not more than 900° C., and still more preferably not more than 800° C.

However, the applicable temperatures can vary depending on the species of zeolite and, for example, the heating temperature in the transition element heating step when the support is ZSM-5 or ZSM-22 is preferably at least 700° C., more preferably at least 750° C., and still more preferably at least 800° C. and is preferably not more than 1,050° C., more preferably not more than 1,000° C., and still more preferably not more than 950° C.

The heating temperature in the transition element heating step when the support is beta is preferably at least 500° C., more preferably at least 600° C., and still more preferably at least 700° C. and is preferably not more than 1,000° C., more preferably not more than 900° C., and still more preferably not more than 800° C.

The atmosphere is ordinarily the ambient environment in which the transition element heating step is carried out.

The catalyst production method should include the aforementioned transition element introduction step and transition element heating step, but is not otherwise particularly limited; however, the catalyst production method preferably includes the main group element introduction step and main group element heating step described below when the catalyst contains at least one main group element selected from the group consisting of Periodic Table group 1 main group elements and group 2 main group elements.

Main group element introduction step: a step of loading the support with at least one main group element selected from the group consisting of Periodic Table group 1 main group elements and group 2 main group elements Main group element heating step: a step of heating a precursor that has gone through the main group element introduction step

The “main group element introduction step” and the “main group element heating step” are described in detail herebelow.

The main group element introduction step is a step of incorporating, in a support, at least one main group element selected from the group consisting of Periodic Table group 1 main group elements and group 2 main group elements; however, the method for incorporating the main group element is not particularly limited and known methods, e.g., impregnation method and ion-exchange method, can be employed as appropriate. A specific example is a method in which the support is brought into contact with an aqueous solution provided by the dissolution of a main group element precursor compound. The detailed conditions for this method for contacting the support with an aqueous solution are described in the following.

In the case of the incorporation of potassium (K), examples of the precursor compound include potassium nitrate (KNO₃), potassium hydroxide (KOH), potassium carbonate (K₂CO₃), potassium sulfate (K₂SO₄), and potassium acetate (KOCOCH₃) In the case of the incorporation of barium (Ba), examples of the precursor compound include barium chloride (BaCl₂), barium nitrate (Ba(NO₃)₂), barium hydroxide (Ba(OH)₂), and barium acetate (Ba(OCOCH₃)₂).

In the case of the incorporation of cesium (Cs), examples of the precursor compound include cesium nitrate (CsNO₃), cesium hydroxide (CsOH), cesium carbonate (Cs₂CO₃), and cesium acetate (CsOCOCH₃).

The concentration of the main group element precursor in the aqueous solution is preferably at least 0.1 mass %, more preferably at least 1 mass %, and still more preferably at least 3 mass % and is preferably not more than 50 mass %, more preferably not more than 30 mass %, and still more preferably not more than 20 mass %.

The temperature of the aqueous solution is preferably at least 5° C., more preferably at least 10° C., and still more preferably at least 15° C. and is preferably not more than 80° C., more preferably not more than 60° C., and still more preferably not more than 50° C.

The contact (impregnation) time between the support and aqueous solution is preferably at least 10 minutes, more preferably at least 30 minutes, and still more preferably at least 1 hour. Although, as the impregnation time is extended, a negative effect in correspondence thereto does not accrue, the impregnation time is, from the standpoint of the catalyst production efficiency, preferably not more than 2 days, more preferably not more than 1 day, and still more preferably not more than 12 hours.

The main group element heating step is a step of heating a precursor that has gone through the main group element introduction step, and the heating temperature, atmosphere, and so forth are described in detail in the following.

The heating temperature in the main group element heating step is generally a temperature that can effect drying, and is preferably at least 100° C. and more preferably at least 110° C. and is preferably not more than 1,000° C., more preferably not more than 900° C., still more preferably not more than 700° C., and particularly preferably not more than 500° C. The heating time after the prescribed temperature has been reached is preferably at least 30 minutes and within 24 hours and is more preferably at least 1 hour and within 12 hours. A catalyst with a higher activity can be produced within these ranges.

The atmosphere is ordinarily the ambient environment in which the main group element heating step is executed.

The catalyst production method should contain the aforementioned support preparation step, transition element introduction step, and transition element heating step, but is not otherwise particularly limited, and examples of the sequence of execution of the support preparation step and so forth include the following embodiments 1 to 3.
Embodiment 1: execution in the sequence of support preparation step, transition element introduction step, and transition element heating step
Embodiment 2: execution in the sequence of support preparation step, transition element introduction step, transition element heating step, main group element introduction step, and main group element heating step
Embodiment 3: execution in the sequence of support preparation step, main group element introduction step, main group element heating step, transition element introduction step, and transition element heating step

The number of executions of the transition element introduction step and so forth is not limited to one each, and these may each be carried out two or more times.

### EXAMPLES

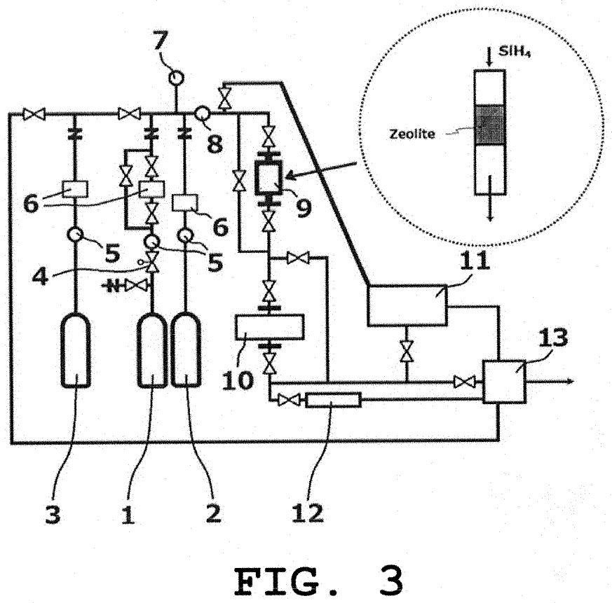

The present invention is described in additional detail using the examples and comparative examples provided below, but modifications can be made as appropriate insofar as there is no departure from the essential features of the present invention. Accordingly, the scope of the present invention should not be construed as being limited to or by the specific examples given below. The examples and comparative examples were carried out by immobilizing the zeolite in a fixed bed within the reaction tube of the reaction apparatus shown in FIG. 3 (schematic diagram) and flowing through a reaction gas containing tetrahydrosilane that had been diluted with helium gas or the like. The produced gas was analyzed using a GC-17A gas chromatograph from Shimadzu Corporation with a TCD (thermal conductivity detector). A yield of 0% was reported when detection by GC did not occur (below the detection limit). Qualitative analysis of the disilane and so forth was performed by MASS (mass analyzer). Although filter 10 included in FIG. 3 is one generally used for sampling of a reaction gas, no sampling operation such as sampling by cooling was included in the Examples, and the reaction gas was directly introduced into the gas chromatograph for analysis. Since the reaction apparatus used in these evaluations is for testing and research, an exclusion apparatus 13 is installed in order to discharge the products from the system in a safe manner.

The pores in the zeolites used are as follows.
Zeolite Y (Y type zeolite) (framework type code: FAU, includes H—Y type zeolite, Na—Y type zeolite, and so forth):

<111> minor diameter=0.74 nm, major diameter=0.74 nm
ZSM-5 (framework type code: MFI, includes H-ZSM-5, NH₄—ZSM-5, and so forth):

<100> minor diameter=0.51 nm, major diameter=0.55 nm

<010> minor diameter=0.53 nm, major diameter=0.56 nm
ZSM-22 (framework type code: TON):

<001> minor diameter=0.46 nm, major diameter=0.57 nm
Beta (beta) (framework type code: BEA):

<100> minor diameter=0.66 nm, major diameter=0.67 nm

<001> minor diameter=0.56 nm, major diameter=0.56 nm
H-mordenite (framework type code: MOR):

<001> minor diameter=0.65 nm, major diameter=0.70 nm

<010> minor diameter=0.34 nm, major diameter=0.48 nm

<001> minor diameter=0.26 nm, major diameter=0.57 nm
H-ferrierite (framework type code: FER):

<001> minor diameter=0.42 nm, major diameter=0.54 nm

<010> minor diameter=0.35 nm, major diameter=0.48 nm

The numerical values for the pore minor diameter and major diameter are taken from “http://www.jaz-online.org/introduction/qanda.html” and “ATLAS OF ZEOLITE FRAMEWORK TYPES, Ch. Baerlocher, L. B. McCusker and D. H. Olson, Sixth Revised Edition 2007, published on behalf of the structure Commission of the international Zeolite Association”

[Preparation of Silica Loaded with a Periodic Table Group 3 Transition Element, Etc.]

### Preparative Example 1: Preparation of Tungsten(W)-Loaded Silica

An aqueous solution of 0.14 g of (NH₄)₁₀W₁₂O₄₁.5H₂O (corresponded to a loading of 1 mass % as W) dissolved in 10 g of distilled water was added to 10 g of silica beads (product name: Q-10, Fuji Silysia Chemical Ltd.) and mixing was carried out for 1 hour. This was followed by drying in the atmosphere for 4 hours at 110° C. and then calcination in the atmosphere for 2 hours at 900° C. to obtain a 1 mass % W-loaded silica powder. In this case, the loaded amount is the mass % as the external value per 1 mass part of the starting zeolite used (this means, if the loaded amount is 1 mass %, W=1 mass part with respect to 100 mass parts of the starting zeolite).

[Preparation of Zeolite Loaded with a Periodic Table Group 3 Transition Element, Etc.]

### Preparative Example 2: Preparation 1 of Tungsten(W)-Loaded Zeolite

An aqueous solution of 0.14 g of (NH₄)₁₀W₁₂O₄₁5H₂O (corresponded to a loading of 1 mass % as W) dissolved in 10 g of heated distilled water was added to 10 g of H—Y type zeolite (silica/alumina ratio=5.5, Tosoh Corporation, JRC-Z-HY5.5 reference catalyst according to the Catalysis Society of Japan) and mixing was carried out for 1 hour while heating. This was followed by drying in the atmosphere for 4 hours at 110° C. and then calcination in the atmosphere for 2 hours at 900° C. to obtain a 1 mass % W-loaded Y-type zeolite powder.

### Preparative Example 3: Preparation 2 of Tungsten(W) Loaded Zeolite

An aqueous solution of 0.28 g of (NH₄)₁₀W₁₂O₄₁.5H₂O (corresponded to a loading of 1 mass % as W) dissolved in 20 g of heated distilled water was added to 20 g of NH₄—ZSM-5 (silica/alumina ratio=23, Tosoh Corporation, product name: HSZ-800 type 820NHA) and mixing was carried out for 1 hour while heating. This was followed by drying in the atmosphere for 4 hours at 110° C. and then calcination in the atmosphere for 2 hours at 900° C. to obtain a 1 mass % W-loaded ZSM-5 (silica/alumina ratio=23) powder.

### Preparative Example 4: Preparation of Molybdenum(Mo)-Loaded Zeolite

20 g of distilled water and 0.37 g of (NH₄)₆Mo₇O₂₄.4H₂O (corresponded to a loading of 1 mass % as Mo) were added to 20 g of NH₄—ZSM-5 (silica/alumina ratio=23, Tosoh Corporation, product name: HSZ-800 type 820NHA) and mixing was carried out for 1 hour at room temperature. This was followed by drying in the atmosphere for 4 hours at 110° C. and then calcination in the atmosphere for 2 hours at 900° C. to obtain a 1 mass % Mo-loaded ZSM-5 (silica/alumina ratio=23) powder.

### Preparative Example 5: Preparation of Vanadium(V)-Loaded Zeolite

An aqueous solution of 0.89 g of VOSO₄.nH₂O (n=3 and 4) (corresponded to a loading of 1 mass % as V) dissolved in 20 g of heated distilled water was added to 20 g of NH₄—ZSM-5 (silica/alumina ratio=23, Tosoh Corporation, product name: HSZ-800 type 820NHA) and mixing was carried out for 1 hour while heating. This was followed by drying in the atmosphere for 4 hours at 110° C. and then calcination in the atmosphere for 2 hours at 900° C. to obtain a 1 mass % V-loaded ZSM-5 (silica/alumina ratio=23) powder.

### Preparative Example 6: Preparation of Titanium(Ti)-Loaded Zeolite

An aqueous solution provided by the dilution of 1.2 g of an aqueous titanium chloride solution (contained 16 mass % of Ti) (corresponded to a loading of 1 mass % as Ti) with 20 g of distilled water was added to 20 g of NH₄—ZSM-5 (silica/alumina ratio=23, Tosoh Corporation, product name: HSZ-800 type 820NHA) and mixing was carried out for 1 hour while heating. This was followed by drying in the atmosphere for 4 hours at 110° C. and then calcination in the atmosphere for 2 hours at 900° C. to obtain a 1 mass % Ti-loaded ZSM-5 (silica/alumina ratio=23) powder.

[Preparation of Silica not Containing a Transition Element]

### Preparative Example 7: Preparation of Silica not Containing a Transition Element

10 g of silica beads (product name: Q-10, Fuji Silysia Chemical Ltd.) was calcined in the atmosphere for 2 hours at 700° C. to obtain a calcined silica.

[Preparation of Zeolite not Containing a Transition Element]

### Preparative Example 8: Preparation 1 of Zeolite not Containing a Transition Element

10 g of H—Y type zeolite (silica/alumina ratio=5.5, Tosoh Corporation, JRC-Z-HY5.5 reference catalyst according to the Catalysis Society of Japan) was dried in the atmosphere for 4 hours at 110° C. and was subsequently calcined in the atmosphere for 2 hours at 900° C. to obtain a calcined Y-type zeolite.

### Preparative Example 9: Preparation 2 of Zeolite not Containing a Transition Element

20 g of NH₄—ZSM-5 (silica/alumina ratio=23, Tosoh Corporation, product name: HSZ-800 type 820NHA) was dried in the atmosphere for 4 hours at 110° C. followed by calcination in the atmosphere for 2 hours at 900° C. to obtain a ZSM-5 (silica/alumina ratio=23) powder that did not contain a transition element.

[Preparation of Zeolite Loaded with a Periodic Table Group 1 Main Group Element, Etc., and a Periodic Table Group 3 Transition Element, Etc.]

### Preparative Example 10: Preparation of K-Containing Molybdenum(Mo)-Loaded Zeolite

5 g of distilled water and 0.32 g of KNO₃ (corresponded to a 2.4 mass % loading as K) were added to 5 g of the 1 mass % Mo-loaded ZSM-5 (silica/alumina ratio=23) prepared in Preparative Example 4 and mixing was carried out for 1 hour at room temperature. This was followed by drying in the atmosphere for 4 hours at 110° C. and then calcination in the atmosphere for 2 hours at 900° C. to obtain a 1 mass % Mo-loaded ZSM-5 (silica/alumina ratio=23) that contained 2.4 mass % of K. Calculation of the value of “(AM/Al)/(1-TM/Al)” in the following formula (1) for the obtained K-containing molybdenum(Mo)-loaded ZSM-5 gave a result of 0.49 (the “Al” was calculated at 1.35 mol/kg from the silica/alumina ratio of the ZSM-5; the “AM” was calculated at 0.61 mol/kg from the K content; and the “TM” was calculated at 0.10 mol/kg from the Mo content (10 g/1.0 kg-support)). Analysis of the overall K content gave 2.1 mass % (the analytical value for K is the content included in the total mass). This analysis was carried using ICP optical emission spectrometry (instrument name: analytikjena PQ9000 (manufacturer: Analytik Jena AG)) and using the following procedure.

The sample was ground with an agate mortar (the grinding step was also carried out on powder samples in order to provide a constant process), and 0.02 g was precisely weighed into a platinum crucible. To this were added 0.50 g of sodium peroxide and 0.50 g of lithium metaborate and fusion was carried out. HF and HNO₃ were added to the fusion and it was peeled from the platinum crucible and ultrapure water was added to dissolve it. This was adjusted to 250 mL and was analyzed by ICP optical emission spectrometry. Serial analysis was performed for each level with n=2, and the individual analytic values and the average value were obtained.

$$[ Math . 5 ]$$

$$0.1 ≦ \frac{AM \text{/} A 1}{1 - TM \text{/} A 1} ≦ 0.9 \qquad ( 1 )$$

### Preparative Example 11: Preparation of K-Containing Tungsten(W)-Loaded Zeolite

5 g of distilled water and 0.32 g of KNO₃ (corresponded to a 2.4 mass % loading as K) were added to 5 g of the 1 mass % W-loaded ZSM-5 (silica/alumina ratio=23) prepared in Preparative Example 3 and mixing was carried out for 1 hour at room temperature. This was followed by drying in the atmosphere for 4 hours at 110° C. and then calcination in the atmosphere for 2 hours at 900° C. to obtain a 1 mass % W-loaded ZSM-5 (silica/alumina ratio=23) that contained 2.4 mass % of K. Calculation of the value of “(AM/Al)/(1-TM/Al)” in formula (1) for the obtained K-containing tungsten(W)-loaded ZSM-5 gave a result of 0.69. Similarly, the overall K content was 2.1 mass %.

### Preparative Example 12: Preparation of Ba-Containing Molybdenum(Mo)-Loaded Zeolite

5 g of distilled water and 0.19 g of BaCl₂ (corresponded to a 2.4 mass % loading as Ba) were added to 5 g of the 1 mass % Mo-loaded ZSM-5 (silica/alumina ratio=23) prepared in Preparative Example 4 and mixing was carried out for 1 hour at room temperature. This was followed by drying in the atmosphere for 4 hours at 110° C. and then calcination in the atmosphere for 2 hours at 900° C. to obtain a 1 mass % Mo-loaded ZSM-5 (silica/alumina ratio=23) that contained 2.4 mass % of Ba. Calculation of the value of “(AM/A1)/(1-TM/Al)” in formula (1) for the obtained Ba-containing molybdenum(Mo)-loaded ZSM-5 gave a result of 0.14. The overall Ba content was 2.3 mass %.

### Preparative Example 13: Preparation of Cs-Containing Molybdenum(Mo)-Loaded Zeolite

5 g of distilled water and 0.18 g of CsNO₃ (corresponded to a 2.4 mass % loading as Cs) were added to 5 g of the 1 mass % Mo-loaded ZSM-5 (silica/alumina ratio=23) prepared in Preparative Example 4 and mixing was carried out for 1 hour at room temperature. This was followed by drying in the atmosphere for 4 hours at 110° C. and then calcination in the atmosphere for 2 hours at 900° C. to obtain a 1 mass % Mo-loaded ZSM-5 (silica/alumina ratio=23) that contained 2.4 mass % of Cs. Calculation of the value of “(AM/Al)/(1-TM/Al)” in formula (1) for the obtained Cs-containing molybdenum(Mo)-loaded ZSM-5 gave a result of 0.15. The overall Cs content was 2.1 mass %.

### Preparative Example 14: Preparation of K-Containing Molybdenum(Mo)-Loaded Zeolite

5 g of distilled water and 0.64 g of KNO₃ (corresponded to a 4.9 mass % loading as K) were added to 5 g of the 1 mass % Mo-loaded ZSM-5 (silica/alumina ratio=23) prepared in Preparative Example 4 and mixing was carried out for 1 hour at room temperature. This was followed by drying in the atmosphere for 4 hours at 110° C. and then calcination in the atmosphere for 2 hours at 900° C. to obtain a 1 mass % Mo-loaded ZSM-5 (silica/alumina ratio=23) that contained 4.9 mass % of K. Calculation of the value of “(AM/Al)/(1-TM/Al)” in formula (1) for the obtained K-containing molybdenum(Mo)-loaded ZSM-5 gave a result of 1.0. The overall K content was 4.6 mass %.

### Preparative Example 15: Preparation of Molybdenum(Mo)-Loaded Zeolite

20 g of distilled water and 0.185 g of (NH₄)₆Mo₇O₂₄.4H₂O (corresponded to a loading of 0.5 mass % as Mo) were added to 20 g of NH₄—ZSM-5 (silica/alumina ratio=40, Tosoh Corporation, product name: HSZ-800 type 840NHA) and mixing was carried out for 1 hour at room temperature. This was followed by drying in the atmosphere for 4 hours at 110° C. and then calcination in the atmosphere for 2 hours at 900° C. to obtain a 0.5 mass % Mo-loaded ZSM-5 (silica/alumina ratio=40) powder.

### Preparative Example 16: Preparation of Ba-Containing Molybdenum(Mo)-Loaded Zeolite

10 g of distilled water and 0.238 g of Ba(NO₃)₂ (corresponded to a 2.5 mass % loading as Ba) were added to 5 g of the 0.5 mass % Mo-loaded ZSM-5 (silica/alumina ratio=40) prepared in Preparative Example 15 and mixing was carried out for 1 hour at room temperature. This was followed by drying in the atmosphere for 4 hours at 110° C. and then calcination in the atmosphere for 2 hours at 900° C. to obtain a 0.5 mass % Mo-loaded ZSM-5 (silica/alumina ratio=40) that contained 2.4 mass % of Ba. Calculation of the value of “(AM/Al)/(1-TM/Al)” in formula (1) for the obtained Ba-containing molybdenum(Mo)-loaded ZSM-5 gave a result of 0.24. The overall Ba content was 2.3 mass %.

### Preparative Example 17: Preparation of Ba-Containing Molybdenum(Mo)-Loaded Zeolite

10 g of distilled water and 0.238 g of Ba(NO₃)₂ (corresponded to a 2.4 mass % loading as Ba) were added to 5 g of NH₄—ZSM-5 (silica/alumina ratio=40, Tosoh Corporation, product name: HSZ-800 type 840NHA) and mixing was carried out for 1 hour at room temperature. This was followed by drying in the atmosphere for 2 hours at 250° C. After drying, 5 g of distilled water and 0.046 g of (NH₄)₆Mo₇O₂₄.4H₂O (corresponded to a loading of 0.5 mass % as Mo) were added and mixing was carried out for 1 hour at room temperature. This was followed by drying in the atmosphere for 4 hours at 110° C. and then calcination in the atmosphere for 2 hours at 900° C. to obtain 0.5 mass % Mo-loaded ZSM-5 (silica/alumina ratio=40) powder that contained 2.4 mass % of Ba. Calculation of the value of “(AM/Al)/(1-TM/Al)” in formula (1) for the obtained Ba-containing molybdenum(Mo)-loaded ZSM-5 gave a result of 0.24. The overall Ba content was 2.3 mass %.

### Preparative Example 18: Preparation of Molybdenum(Mo)-Loaded Zeolite Pellets

20 g of distilled water and 0.37 g of (NH₄)₆Mo₇O₂₄.4H₂O (corresponded to a loading of 1 mass % as Mo) were added to 20 g of H-ZSM-5 pellets (silica/alumina ratio=23, Tosoh Corporation, product name: HSZ type 822HOD3A, contained 18 to 22 mass % alumina (SDS stated value)) and mixing was carried out for 1 hour at room temperature. This was followed by drying in the atmosphere for 4 hours at 110° C. and then calcination in the atmosphere for 2 hours at 700° C. to obtain 1 mass % Mo-loaded ZSM-5 (pellets).

### Preparative Example 19: Preparation of Molybdenum(Mo)-Loaded Zeolite Pellets

10 g of distilled water and 0.131 g of (NH₄)₆Mo₇O₂₄.4H₂O (corresponded to a loading of 0.5 mass % as Mo) were added to 14.2 g of H-ZSM-5 pellets (silica/alumina ratio=23, Tosoh Corporation, product name: HSZ type 822HOD3A, contained 18 to 22 mass % alumina (SDS stated value)) and mixing was carried out for 1 hour at room temperature. This was followed by drying in the atmosphere for 4 hours at 110° C. and then calcination in the atmosphere for 2 hours at 700° C. to obtain 0.5 mass % Mo-loaded ZSM-5 (pellets).

### Preparative Example 20: Preparation of Ba-Containing Molybdenum(Mo)-Loaded Zeolite Pellets

10 g of distilled water and 0.238 g of Ba(NO₃)₂ (corresponded to a 2.4 mass % loading as Ba) were added to 5 g of the 0.5 mass % Mo-loaded ZSM-5 pellets prepared in Preparative Example 19 and mixing was carried out for 1 hour at room temperature. This was followed by drying in the atmosphere for 4 hours at 110° C. and then calcination for 2 hours at 700° C. to obtain a 0.5 mass % Mo-loaded ZSM-5 (pellets) that contained 2.4 mass % of Ba. Calculation of the value of “(AM/Al)/(1-TM/Al)” in formula (1) for the obtained Ba-containing molybdenum(Mo)-loaded ZSM-5 pellets gave a result of 0.18 (contained 20% binder, the calculation was performed considering this fraction). The overall Ba content was 2.3 mass %.

### Preparative Example 21: Preparation of Molybdenum(Mo)-Loaded Zeolite Pellets

20 g of distilled water and 0.37 g of (NH₄)₆Mo₇O₂₄.4H₂O (corresponded to a loading of 1 mass % as Mo) were added to 20 g of H-beta pellets (silica/alumina ratio=17.1, Tosoh Corporation, product name: HSZ type 920HOD1A, contained 18 to 22 mass % alumina (SDS stated value)) and mixing was carried out for 1 hour at room temperature. This was followed by drying in the atmosphere for 4 hours at 110° C. and then calcination in the atmosphere for 6 hours at 600° C. to obtain 1 mass % Mo-loaded beta (pellets).

### Preparative Example 22: Preparation of Molybdenum(Mo)-Loaded Zeolite Pellets

20 g of distilled water and 0.37 g of (NH₄)₆Mo₇O₂₄.4H₂O (corresponded to a loading of 1 mass % as Mo) were added to 20 g of H-mordenite pellets (silica/alumina ratio=17.8, Tosoh Corporation, product name: HSZ type 640HOD1A, contained 18 to 22 mass % alumina (SDS stated value)) and mixing was carried out for 1 hour at room temperature. This was followed by drying in the atmosphere for 4 hours at 110° C. and then calcination in the atmosphere for 6 hours at 600° C. to obtain 1 mass % Mo-loaded mordenite (pellets).

### Preparative Example 23: Preparation of Molybdenum(Mo)-Loaded Zeolite Pellets

20 g of distilled water and 0.37 g of (NH₄)₆Mo₇O₂₄.4H₂O (corresponded to a loading of 1 mass % as Mo) were added to 20 g of H-ferrierite pellets (silica/alumina ratio=18.7, Tosoh Corporation, product name: HSZ type 722HOD1A, contained 18 to 22 mass % alumina (SDS stated value)) and mixing was carried out for 1 hour at room temperature. This was followed by drying in the atmosphere for 4 hours at 110° C. and then calcination in the atmosphere for 6 hours at 600° C. to obtain 1 mass % Mo-loaded ferrierite (pellets).

### Preparative Example 24: Preparation of Molybdenum(Mo)-Loaded Zeolite Pellets

20 g of distilled water and 0.37 g of (NH₄)₆Mo₇O₂₄.4H₂O (corresponded to a loading of 1 mass % as Mo) were added to 20 g of H—Y pellets (silica/alumina ratio=6.1, Tosoh Corporation, product name: HSZ type 330HOD1A, contained 18 to 22 mass % alumina (SDS stated value)) and mixing was carried out for 1 hour at room temperature. This was followed by drying in the atmosphere for 4 hours at 110° C. and then calcination in the atmosphere for 6 hours at 600° C. to obtain 1 mass % Mo-loaded Y (pellets).

### Preparative Example 25: Preparation of Molybdenum(Mo)-Loaded Zeolite Pellets

1 mass % Mo-loaded ZSM-5 (pellets) was obtained by preparing a catalyst as in Preparative Example 18, except for changing the calcination temperature from 700° C. to 900° C.

### Preparative Example 26: Preparation of Ba-Containing Molybdenum(Mo)-Loaded Zeolite Pellets

Pure water was added to 1.78 g of a 40 mass % aqueous solution of barium acetate (Osaki Industry Co., Ltd.) (corresponded to a loading of 2.4 mass % as Ba) to bring to 6.0 mL, and this was impregnated into 14.2 g of H-ZSM-5 pellets (silica/alumina ratio=23, Tosoh Corporation, product name: HSZ type 822HOD3A, contained 18 to 22 mass % alumina (SDS stated value)) and drying was carried out for 2 hours at 110° C. The dried support was impregnated using 5.0 mL of an aqueous solution that contained 0.261 g of (NH₄)₆Mo₇O₂₄.4H₂O (corresponded to a 1 mass % loading as Mo). Air drying was carried out for 1 hour followed by drying in the atmosphere for 2 hours at 110° C. and then calcination in the atmosphere for 2 hours at 900° C. to obtain a 1.0 mass % Mo-loaded ZSM-5 (pellets) that contained 2.4 mass % of Ba. Calculation of the value of “(AM/Al)/(1-TM/Al)” in formula (1) for the obtained Ba-containing molybdenum(Mo)-loaded ZSM-5 pellets gave a result of 0.14 (contained 20% binder, the calculation was performed considering this fraction).

### Preparative Example 27: Preparation of Manganese(Mn)-Loaded Zeolite Pellets

20.0 g of H-ZSM-5 pellets (silica/alumina ratio=23, Tosoh Corporation, product name: HSZ type 822HOD3A, contained 18 to 22 mass % alumina (SDS stated value)) was impregnated with an aqueous solution of 0.72 g of manganese chloride tetrahydrate MnCl₂.4H₂O (Wako Pure Chemical Industries, Ltd.) (corresponded to a loading of 1 mass % as Mn) dissolved in 8.4 g of water. Air drying was carried out for 1 hour followed by drying in the atmosphere for 2 hours at 110° C. and then calcination in the atmosphere for 2 hours at 700° C. to obtain a 1.0 mass % Mn-loaded ZSM-5 (pellets).

### Preparative Example 28: Preparation of Vanadium(V)-Loaded Zeolite Pellets

20.0 g of H-ZSM-5 pellets (silica/alumina ratio=23, Tosoh Corporation, product name: HSZ type 822HOD3A, contained 18 to 22 mass % alumina (SDS stated value)) was impregnated with an aqueous solution of 0.88 g of vanadium oxyoxalate V(C₂O₄)O.nH₂O (contained approximately 40 mass % of oxalic acid, Wako Pure Chemical Industries, Ltd., purity analysis value=58.8 mass %) (corresponded to a loading of 0.84 mass % as V) dissolved in 8.4 g of water. Air drying was carried out for 1 hour followed by drying in the atmosphere for 2 hours at 110° C. and then calcination in the atmosphere for 2 hours at 900° C. to obtain a 0.8 mass % V-loaded ZSM-5 (pellets).

### Preparative Example 29: Preparation of Niobium(Nb)-Loaded Zeolite Pellets

20.0 g of H-ZSM-5 pellets (silica/alumina ratio=23, Tosoh Corporation, product name: HSZ type 822HOD3A, contained 18 to 22 mass % alumina (SDS stated value)) was impregnated with an aqueous solution of 0.46 g of niobium ammonium oxalate (NH₄) [Nb(O) (C₂O₄)₂(H₂O)₂] (H.C. Starck GmbH) (corresponded to a loading of 1 mass % as Nb) dissolved in 4.2 g of hot water. Air drying was carried out for 1 hour followed by drying in the atmosphere for 2 hours at 110° C. and then calcination in the atmosphere for 2 hours at 900° C. to obtain a 1.0 mass % Nb-loaded ZSM-5 (pellets).

### Preparative Example 30: Preparation of Zeolite Pellets Loaded with Molybdenum(Mo) Using Molybdenum Oxide

20.0 g of H-ZSM-5 pellets (silica/alumina ratio=23, Tosoh Corporation, product name: HSZ type 822HOD3A, contained 18 to 22 mass % alumina (SDS stated value)) was introduced into a beaker. 1 g of water was added to 0.30 g of molybdenum oxide (Wako Pure Chemical Industries, Ltd.) (corresponded to a loading of 1 mass % as Mo) and this was ground with a mortar. Transfer was then carried out, while washing with 7.4 g of water, to the beaker holding the zeolite pellets, and shaking was performed to bring about mixing to uniformity as much as possible (molybdenum oxide does not dissolve in water, and mixing was thus carried out in the form of a milky white slurry). The mixed pellets were dried in the atmosphere for 2 hours at 110° C. followed by calcination in the atmosphere for 2 hours at 900° C. to obtain a ZSM-5 (pellets) loaded with 1.0 mass % Mo using molybdenum oxide.

### Preparative Example 31: Preparation of Chromium(Cr)-Loaded Zeolite Powder

2.05 g of ZSM-22 powder (ACS Material, LLC, silica/alumina ratio=65 to 80, value provided at website) was impregnated with an aqueous solution of 0.059 g of ammonium chromate (NH₄)₂CrO₄ (Wako Pure Chemical Industries, Ltd.) (corresponded to a loading of 1 mass % as Cr) dissolved in 4 g of water. Air drying was carried out for 1 hour followed by drying in the atmosphere for 2 hours at 110° C. and then calcination in the atmosphere for 2 hours at 700° C. to obtain a 1.0 mass % Cr-loaded ZSM-22 (powder).

[Production of Oligosilane in the Presence of Catalyst Containing a Periodic Table Group 3 Transition Element]

### Example 1

1.0 g of the 1 mass % W-loaded silica prepared in Preparative Example 1 was placed in a reaction tube and the air was removed from the reaction tube using a vacuum pump and substitution with helium gas was then carried out. The helium gas was caused to flow through at a rate of 20 mL/minute and the temperature was raised to 200° C., after which throughflow was performed for 1 hour. Then, an argon/silane mixed gas (Ar: 20%, SiH₄: 80% (volume ratio)) at 2 mL/minute, hydrogen gas at 2 mL/minute, and helium gas at 16 mL/minute were mixed in a gas mixer and caused to flow through. After 5 minutes, the argon/silane mixed gas was changed to 1 mL/minute, the hydrogen gas was changed to 1 mL/minute, and the helium gas was changed to 8 mL/minute. After the elapse of each time as shown in Table 1, the composition of the reaction gas was analyzed by gas chromatography and the silane conversion, disilane yield, selectivity for disilane, and space-time yield (STY) for disilane were calculated. The results are given in Table 1. In the table, the “contact (residence) time” is the residence time within the reactor of the gas flowing through the reactor, i.e., it is the contact time between the hydrosilane and catalyst. The space-time yield (STY) for disilane was calculated using the following formula.

STY=mass of disilane produced per 1 hour/volume of catalyst

TABLE 1

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 3.1 | 0.1 | 4 | 34 | 0.1 |
| 200 | 2 | 0.8 | 0.2 | 8 | 1 | 2.7 | 0.1 | 5 | 34 | 0.1 |
| 200 | 3 | 0.8 | 0.2 | 8 | 1 | 0.5 | 0.1 | 25 | 34 | 0.1 |

### Comparative Example 1

A reaction was run under the same conditions as in Example 1, except for changing the 1.0 g of 1 mass % W-loaded silica prepared in Preparative Example 1 to 1.0 g of the calcined silica prepared in Preparative Example 7. After the elapse of each time as shown in Table 2, the composition of the reaction gas was analyzed by gas chromatography as in Example 1 and the silane conversion, disilane yield, selectivity for disilane, and space-time yield (STY) for disilane were calculated. The results are given in Table 2.

TABLE 2

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 2.6 | 0 | 0 | 34 | 0.0 |
| 200 | 2 | 0.8 | 0.2 | 8 | 1 | 2.5 | 0 | 0 | 34 | 0.0 |
| 200 | 3 | 0.8 | 0.2 | 8 | 1 | 0.9 | 0 | 0 | 34 | 0.0 |

### Example 2

A reaction was run under the same conditions as in Example 1, except for changing the 1.0 g of 1 mass % W-loaded silica prepared in Preparative Example 1 to 1.0 g of the 1 mass % W-loaded Y-type zeolite prepared in Preparative Example 2. After the elapse of each time as shown in Table 3, the composition of the reaction gas was analyzed by gas chromatography as in Example 1 and the silane conversion, disilane yield, selectivity for disilane, and space-time yield (STY) for disilane were calculated. The results are given in Table 3.

TABLE 3

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 3.1 | 1.2 | 38 | 34 | 0.7 |
| 200 | 2 | 0.8 | 0.2 | 8 | 1 | 6.0 | 1.1 | 19 | 34 | 0.7 |
| 200 | 3 | 0.8 | 0.2 | 8 | 1 | 5.1 | 1.2 | 23 | 34 | 0.7 |
| 200 | 4 | 0.8 | 0.2 | 8 | 1 | 4.0 | 1.2 | 29 | 34 | 0.8 |
| 200 | 5 | 0.8 | 0.2 | 8 | 1 | 2.0 | 1.2 | 60 | 34 | 0.8 |
| 200 | 6 | 0.8 | 0.2 | 8 | 1 | 1.3 | 1.2 | 97 | 34 | 0.8 |

### Comparative Example 2

A reaction was run under the same conditions as in Example 1, except for changing the 1.0 g of 1 mass % W-loaded silica prepared in Preparative Example 1 to 1.0 g of the calcined Y-type zeolite prepared in Preparative Example 8. After the elapse of each time as shown in Table 4, the composition of the reaction gas was analyzed by gas chromatography as in Example 1 and the silane conversion, disilane yield, selectivity for disilane, and space-time yield (STY) for disilane were calculated. The results are given in Table 4.

TABLE 4

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 1.4 | 0 | 0 | 34 | 0.0 |
| 200 | 2 | 0.8 | 0.2 | 8 | 1 | 1.3 | 0 | 0 | 34 | 0.0 |
| 200 | 3 | 0.8 | 0.2 | 8 | 1 | 4.2 | 0 | 0 | 34 | 0.0 |

### Example 3

A reaction was run under the same conditions as in Example 1, except for changing the 1.0 g of 1 mass % W-loaded silica prepared in Preparative Example 1 to 1.0 g of the 1 mass % W-loaded ZSM-5 (silica/alumina ratio=23) prepared in Preparative Example 3. After the elapse of each time as shown in Table 5, the composition of the reaction gas was analyzed by gas chromatography as in Example 1 and the silane conversion, disilane yield, selectivity for disilane, and space-time yield (STY) for disilane were calculated. The results are given in Table 5.

TABLE 5

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | {me | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 19.6 | 4.5 | 23 | 34 | 2.9 |
| 200 | 2 | 0.8 | 0.2 | 8 | 1 | 10.0 | 4.8 | 48 | 34 | 3.1 |
| 200 | 3 | 0.8 | 0.2 | 8 | 1 | 10.8 | 4.7 | 44 | 34 | 3.0 |
| 200 | 4 | 0.8 | 0.2 | 8 | 1 | 12.0 | 5.2 | 43 | 34 | 3.3 |
| 200 | 5 | 0.8 | 0.2 | 8 | 1 | 10.5 | 5.4 | 51 | 34 | 3.5 |
| 200 | 6 | 0.8 | 0.2 | 8 | 1 | 9.3 | 5.3 | 57 | 34 | 3.4 |

### Example 4

A reaction was run under the same conditions as in Example 1, except for changing the 1.0 g of 1 mass % W-loaded silica prepared in Preparative Example 1 to 1.0 g of the 1 mass % Mo-loaded ZSM-5 (silica/alumina ratio=23) prepared in Preparative Example 4. After the elapse of each time as shown in Table 6, the composition of the reaction gas was analyzed by gas chromatography as in Example 1 and the silane conversion, disilane yield, selectivity for disilane, and space-time yield (STY) for disilane were calculated. The results are given in Table 6.

TABLE 6

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 32.5 | 2.4 | 7 | 34 | 1.5 |
| 200 | 2 | 0.8 | 0.2 | 8 | 1 | 16.8 | 4.3 | 26 | 34 | 2.8 |
| 200 | 3 | 0.8 | 0.2 | 8 | 1 | 13.4 | 4.8 | 36 | 34 | 3.1 |
| 200 | 4 | 0.8 | 0.2 | 8 | 1 | 12.4 | 5.3 | 43 | 34 | 3.4 |
| 200 | 5 | 0.8 | 0.2 | 8 | 1 | 11.9 | 5.5 | 46 | 34 | 3.5 |
| 200 | 6 | 0.8 | 0.2 | 8 | 1 | 11.1 | 5.5 | 49 | 34 | 3.5 |

### Example 5

A reaction was run under the same conditions as in Example 1, except for changing the 1.0 g of 1 mass % W-loaded silica prepared in Preparative Example 1 to 1.0 g of the 1 mass % V-loaded ZSM-5 (silica/alumina ratio=23) prepared in Preparative Example 5. After the elapse of each time as shown in Table 7, the composition of the reaction gas was analyzed by gas chromatography as in Example 1 and the silane conversion, disilane yield, selectivity for disilane, and space-time yield (STY) for disilane were calculated. The results are given in Table 7.

TABLE 7

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 35.9 | 2.1 | 6 | 34 | 1.3 |
| 200 | 2 | 0.8 | 0.2 | 8 | 1 | 20.4 | 3.8 | 19 | 34 | 2.4 |
| 200 | 3 | 0.8 | 0.2 | 8 | 1 | 16.0 | 4.5 | 28 | 34 | 2.9 |
| 200 | 4 | 0.8 | 0.2 | 8 | 1 | 13.0 | 4.9 | 38 | 34 | 3.2 |
| 200 | 5 | 0.8 | 0.2 | 8 | 1 | 12.4 | 5.1 | 41 | 34 | 3.3 |
| 200 | 6 | 0.8 | 0.2 | 8 | 1 | 12.2 | 5.2 | 42 | 34 | 3.3 |

### Example 6

A reaction was run under the same conditions as in Example 1, except for changing the 1.0 g of 1 mass % W-loaded silica prepared in Preparative Example 1 to 1.0 g of the 1 mass % Ti-loaded ZSM-5 (silica/alumina ratio=23) prepared in Preparative Example 6. After the elapse of each time as shown in Table 8, the composition of the reaction gas was analyzed by gas chromatography as in Example 1 and the silane conversion, disilane yield, selectivity for disilane, and space-time yield (STY) for disilane were calculated. The results are given in Table 8.

TABLE 8

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 6.8 | 1.3 | 19 | 34 | 0.8 |
| 200 | 2 | 0.8 | 0.2 | 8 | 1 | 3.6 | 1.7 | 47 | 34 | 1.1 |
| 200 | 3 | 0.8 | 0.2 | 8 | 1 | 3.4 | 1.9 | 28 | 34 | 1.2 |
| 200 | 4 | 0.8 | 0.2 | 8 | 1 | 2.2 | 2.0 | 42 | 34 | 1.3 |

### Comparative Example 3

A reaction was run under the same conditions as in Example 1, except for changing the 1.0 g of 1 mass % W-loaded silica prepared in Preparative Example 1 to 1.0 g of the ZSM-5 (silica/alumina ratio=23) prepared in Preparative Example 9. After the elapse of each time as shown in Table 9, the composition of the reaction gas was analyzed by gas chromatography as in Example 1 and the silane conversion, disilane yield, selectivity for disilane, and space-time yield (STY) for disilane were calculated. The results are given in Table 9.

TABLE 9

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 8.1 | 0.8 | 10 | 34 | 0.5 |
| 200 | 2 | 0.8 | 0.2 | 8 | 1 | 4.8 | 1.0 | 21 | 34 | 0.6 |
| 200 | 3 | 0.8 | 0.2 | 8 | 1 | 4.8 | 1.2 | 25 | 34 | 0.8 |
| 200 | 4 | 0.8 | 0.2 | 8 | 1 | 3.1 | 1.2 | 37 | 34 | 0.7 |

### Example 7

A reaction was run under the same conditions as in Example 1, except for changing the 1.0 g of 1 mass % W-loaded silica prepared in Preparative Example 1 to 1.0 g of the 1 mass % Mo-loaded ZSM-5 (silica/alumina ratio=23) containing 2.4 mass % K prepared in Preparative Example 10. After the elapse of each time as shown in Table 10, the composition of the reaction gas was analyzed by gas chromatography as in Example 1 and the silane conversion, disilane yield, selectivity for disilane, and space-time yield (STY) for disilane were calculated. The results are given in Table 10.

TABLE 10

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 22.1 | 3.9 | 17 | 34 | 2.5 |
| 200 | 2 | 0.8 | 0.2 | 8 | 1 | 16.7 | 4.7 | 28 | 34 | 3.0 |
| 200 | 3 | 0.8 | 0.2 | 8 | 1 | 13.5 | 5.1 | 38 | 34 | 3.3 |
| 200 | 4 | 0.8 | 0.2 | 8 | 1 | 12.1 | 5.2 | 43 | 34 | 3.3 |
| 200 | 5 | 0.8 | 0.2 | 8 | 1 | 13.1 | 5.4 | 41 | 34 | 3.5 |
| 200 | 6 | 0.8 | 0.2 | 8 | 1 | 12.7 | 5.4 | 43 | 34 | 3.5 |

### Example 8

A reaction was run under the same conditions as in Example 1, except for changing the 1.0 g of 1 mass % W-loaded silica prepared in Preparative Example 1 to 1.0 q of the 1 mass % W-loaded ZSM-5 (silica/alumina ratio=23) containing 2.4 mass % K prepared in Preparative Example 11. After the elapse of each time as shown in Table 11, the composition of the reaction gas was analyzed by gas chromatography as in Example 1 and the silane conversion, disilane yield, selectivity for disilane, and space-time yield (STY) for disilane were calculated. The results are given in Table 11.

TABLE 11

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 13.4 | 4.9 | 36 | 34 | 3.1 |
| 200 | 2 | 0.8 | 0.2 | 8 | 1 | 12.4 | 5.2 | 42 | 34 | 3.3 |
| 200 | 3 | 0.8 | 0.2 | 8 | 1 | 11.9 | 5.4 | 45 | 34 | 3.5 |
| 200 | 4 | 0.8 | 0.2 | 8 | 1 | 11.3 | 5.4 | 48 | 34 | 3.5 |
| 200 | 5 | 0.8 | 0.2 | 8 | 1 | 11.1 | 5.4 | 49 | 34 | 3.5 |
| 200 | 6 | 0.8 | 0.2 | 8 | 1 | 9.6 | 5.7 | 59 | 34 | 3.6 |

### Example 9

A reaction was run under the same conditions as in Example 1, except for changing the 1.0 g of 1 mass % W-loaded silica prepared in Preparative Example 1 to 1.0 g of the 1 mass % Mo-loaded ZSM-5 (silica/alumina ratio=23) containing 2.4 mass % Ba prepared in Preparative Example 12. After the elapse of each time as shown in Table 12, the composition of the reaction gas was analyzed by gas chromatography as in Example 1 and the silane conversion, disilane yield, selectivity for disilane, and space-time yield (STY) for disilane were calculated. The results are given in Table 12.

TABLE 12

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C] | [h] | Silane | Ar | He | H₂ | conversion [%] | yield [%] | for disilane [%] | [second] | [g/kgh] |
| 200 | 1 | 0.8 | 0.2 | 8 | 1 | 25.3 | 3.6 | 14 | 34 | 2.3 |
| 200 | 2 | 0.8 | 0.2 | 8 | 1 | 18.1 | 4.7 | 26 | 34 | 3.0 |
| 200 | 3 | 0.8 | 0.2 | 8 | 1 | 14.8 | 5.2 | 35 | 34 | 3.3 |
| 200 | 4 | 0.8 | 0.2 | 8 | 1 | 12.8 | 5.6 | 43 | 34 | 3.6 |
| 200 | 5 | 0.8 | 0.2 | 8 | 1 | 12.3 | 5.7 | 46 | 34 | 3.7 |
| 200 | 6 | 0.8 | 0.2 | 8 | 1 | 11.8 | 5.6 | 47 | 34 | 3.6 |

### Example 10

A reaction was run under the same conditions as in Example 1, except for changing the 1.0 g of 1 mass % W-loaded silica prepared in Preparative Example 1 to 1.0 g of the 1 mass % Mo-loaded ZSM-5 (silica/alumina ratio=23) containing 2.4 mass % Cs prepared in Preparative Example 13. After the elapse of each time as shown in Table 13, the composition of the reaction gas was analyzed by gas chromatography as in Example 1 and the silane conversion, disilane yield, selectivity for disilane, and space-time yield (STY) for disilane were calculated. The results are given in Table 13.

TABLE 13

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 27.1 | 3.5 | 13 | 34 | 2.2 |
| 200 | 2 | 0.8 | 0.2 | 8 | 1 | 20.1 | 4.5 | 22 | 34 | 2.9 |
| 200 | 3 | 0.8 | 0.2 | 8 | 1 | 15.6 | 5.0 | 32 | 34 | 3.2 |
| 200 | 4 | 0.8 | 0.2 | 8 | 1 | 13.6 | 5.2 | 38 | 34 | 3.3 |
| 200 | 5 | 0.8 | 0.2 | 8 | 1 | 13.8 | 5.5 | 40 | 34 | 3.5 |
| 200 | 6 | 0.8 | 0.2 | 8 | 1 | 12.1 | 5.5 | 45 | 34 | 3.5 |

### Example 11

A reaction was run under the same conditions as in Example 1, except for changing the 1.0 g of 1 mass % W-loaded silica prepared in Preparative Example 1 to 1.0 g of the 1 mass % Mo-loaded ZSM-5 containing 4.9 mass % of K (“(AM/Al)/(1-TM/Al)”=1.0) prepared in Preparative Example 14. After the elapse of each time as shown in Table 14, the composition of the reaction gas was analyzed by gas chromatography as in Example 1 and the silane conversion, disilane yield, selectivity for disilane, and space-time yield (STY) for disilane were calculated. The results are given in Table 14.

TABLE 14

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 7.1 | 2.8 | 39 | 34 | 1.8 |
| 200 | 2 | 0.8 | 0.2 | 8 | 1 | 5.1 | 2.1 | 41 | 34 | 1.3 |
| 200 | 3 | 0.8 | 0.2 | 8 | 1 | 3.0 | 1.8 | 60 | 34 | 1.2 |
| 200 | 4 | 0.8 | 0.2 | 8 | 1 | 3.0 | 1.7 | 57 | 34 | 1.1 |
| 200 | 5 | 0.8 | 0.2 | 8 | 1 | 2.9 | 1.6 | 55 | 34 | 1.0 |
| 200 | 6 | 0.8 | 0.2 | 8 | 1 | 2.7 | 1.5 | 56 | 34 | 1.0 |

### Example 12

A reaction was run under the same conditions as in Example 1, except for changing the 1.0 g of 1 mass % W-loaded silica prepared in Preparative Example 1 to 1.0 g of the 0.5 mass % Mo-loaded ZSM-5 (silica/alumina ratio=40) prepared in Preparative Example 15. After the elapse of each time as shown in Table 15, the composition of the reaction gas was analyzed by gas chromatography as in Example 1 and the silane conversion, disilane yield, selectivity for disilane, and space-time yield (STY) for disilane were calculated. The results are given in Table 15.

TABLE 15

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 30.8 | 2.3 | 7 | 34 | 1.5 |
| 200 | 2 | 0.8 | 0.2 | 8 | 1 | 18.7 | 4.5 | 24 | 34 | 2.9 |
| 200 | 3 | 0.8 | 0.2 | 8 | 1 | 14.2 | 4.6 | 32 | 34 | 3.0 |
| 200 | 4 | 0.8 | 0.2 | 8 | 1 | 12.1 | 5.1 | 42 | 34 | 3.3 |
| 200 | 5 | 0.8 | 0.2 | 8 | 1 | 10.6 | 5.2 | 49 | 34 | 3.3 |
| 200 | 6 | 0.8 | 0.2 | 8 | 1 | 10.7 | 5.2 | 49 | 34 | 3.3 |

### Example 13

A reaction was run under the same conditions as in Example 1, except for changing the 1.0 g of 1 mass % W-loaded silica prepared in Preparative Example 1 to 1.0 g of the 0.5 mass % Mo-loaded ZSM-5 (silica/alumina ratio=40) containing 2.4 mass % of Ba (“(AM/Al)/(1-TM/Al)”=0.24) prepared in Preparative Example 16. After the elapse of each time as shown in Table 16, the composition of the reaction gas was analyzed by gas chromatography as in Example 1 and the silane conversion, disilane yield, selectivity for disilane, and space-time yield (STY) for disilane were calculated. The results are given in Table 16.

TABLE 16

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 22.3 | 3.5 | 16 | 34 | 2.2 |
| 200 | 2 | 0.8 | 0.2 | 8 | 1 | 17.2 | 4.8 | 28 | 34 | 3.1 |
| 200 | 3 | 0.8 | 0.2 | 8 | 1 | 14.1 | 5.4 | 38 | 34 | 3.5 |
| 200 | 4 | 0.8 | 0.2 | 8 | 1 | 12.8 | 5.8 | 45 | 34 | 3.7 |
| 200 | 5 | 0.8 | 0.2 | 8 | 1 | 11.3 | 6.0 | 53 | 34 | 3.9 |
| 200 | 6 | 0.8 | 0.2 | 8 | 1 | 11.1 | 6.1 | 55 | 34 | 3.9 |

### Example 14

A reaction was run under the same conditions as in Example 1, except for changing the 1.0 g of 1 mass % W-loaded silica prepared in Preparative Example 1 to 1.0 g of the 0.5 mass % Mo-loaded ZSM-5 (silica/alumina ratio=40) containing 2.4 mass % of Ba (“(AM/Al)/(1 TM/Al)”=0.24) prepared in Preparative Example 17. After the elapse of each time as shown in Table 17, the composition of the reaction gas was analyzed by gas chromatography as in Example 1 and the silane conversion, disilane yield, selectivity for disilane, and space-time yield (STY) for disilane were calculated. The results are given in Table 17.

TABLE 17

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 18.9 | 3.3 | 17 | 34 | 2.1 |
| 200 | 2 | 0.8 | 0.2 | 8 | 1 | 17.0 | 4.5 | 26 | 34 | 2.9 |
| 200 | 3 | 0.8 | 0.2 | 8 | 1 | 13.7 | 5.1 | 37 | 34 | 3.3 |
| 200 | 4 | 0.8 | 0.2 | 8 | 1 | 11.8 | 5.6 | 47 | 34 | 3.6 |
| 200 | 5 | 0.8 | 0.2 | 8 | 1 | 10.5 | 5.8 | 55 | 34 | 3.7 |
| 200 | 6 | 0.8 | 0.2 | 8 | 1 | 10.6 | 5.7 | 54 | 34 | 3.7 |

### Example 15

A reaction was run under the same conditions as in Example 1, except for changing the 1.0 g of 1 mass % W-loaded silica prepared in Preparative Example 1 to 1.0 g of the 1.0 mass % Mo-loaded ZSM-5 (silica/alumina ratio=23, pellets) prepared in Preparative Example 18. After the elapse of each time as shown in Table 18, the composition of the reaction gas was analyzed by gas chromatography as in Example 1 and the silane conversion, disilane yield, selectivity for disilane, and space-time yield (STY) for disilane were calculated. The results are given in Table 18.

TABLE 18

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 36.4 | 3.2 | 9 | 34 | 2.1 |
| 200 | 2 | 0.8 | 0.2 | 8 | 1 | 21.2 | 4.7 | 22 | 34 | 3.0 |
| 200 | 3 | 0.8 | 0.2 | 8 | 1 | 15.4 | 5.2 | 34 | 34 | 3.3 |
| 200 | 4 | 0.8 | 0.2 | 8 | 1 | 13.2 | 5.5 | 42 | 34 | 3.5 |
| 200 | 5 | 0.8 | 0.2 | 8 | 1 | 12.1 | 5.4 | 45 | 34 | 3.5 |
| 200 | 6 | 0.8 | 0.2 | 8 | 1 | 12.5 | 5.6 | 45 | 34 | 3.6 |

### Example 16

A reaction was run under the same conditions as in Example 1, except for changing the 1.0 g of 1 mass % W-loaded silica prepared in Preparative Example 1 to 1.0 g of the 0.5 mass % Mo-loaded ZSM-5 (silica/alumina ratio=23, pellets) (“(AM/Al)/(1-TM/Al)”=0.18) prepared in Preparative Example 19. After the elapse of each time as shown in Table 19, the composition of the reaction gas was analyzed by gas chromatography as in Example 1 and the silane conversion, disilane yield, selectivity for disilane, and space-time yield (STY) for disilane were calculated. The results are given in Table 19.

TABLE 19

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 33.4 | 3.0 | 9 | 34 | 1.9 |
| 200 | 2 | 0.8 | 0.2 | 8 | 1 | 20.5 | 4.4 | 21 | 34 | 2.8 |
| 200 | 3 | 0.8 | 0.2 | 8 | 1 | 14.6 | 4.9 | 34 | 34 | 3.1 |
| 200 | 4 | 0.8 | 0.2 | 8 | 1 | 12.6 | 4.7 | 37 | 34 | 3.0 |
| 200 | 5 | 0.8 | 0.2 | 8 | 1 | 12.8 | 4.8 | 38 | 34 | 3.1 |
| 200 | 6 | 0.8 | 0.2 | 8 | 1 | 12.3 | 4.7 | 38 | 34 | 3.0 |

### Example 17

A reaction was run under the same conditions as in Example 1, except for changing the 1.0 g of 1 mass % W-loaded silica prepared in Preparative Example 1 to 1.0 g of the 0.5 mass % Mo-loaded ZSM-5 (silica/alumina ratio=23, pellets) containing 2.4 mass % of Ba (“(AM/Al)/(1-TM/Al)”=0.18) prepared in Preparative Example 20. After the elapse of each time as shown in Table 20, the composition of the reaction gas was analyzed by gas chromatography as in Example 1 and the silane conversion, disilane yield, selectivity for disilane, and space-time yield (STY) for disilane were calculated. The results are given in Table 20.

TABLE 20

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 21.3 | 4.1 | 19 | 34 | 2.6 |
| 200 | 2 | 0.8 | 0.2 | 8 | 1 | 19.8 | 5.2 | 26 | 34 | 3.3 |
| 200 | 3 | 0.8 | 0.2 | 8 | 1 | 16.7 | 5.5 | 33 | 34 | 3.5 |
| 200 | 4 | 0.8 | 0.2 | 8 | 1 | 15.3 | 5.8 | 38 | 34 | 3.7 |
| 200 | 5 | 0.8 | 0.2 | 8 | 1 | 12.8 | 5.6 | 44 | 34 | 3.6 |
| 200 | 6 | 0.8 | 0.2 | 8 | 1 | 12.8 | 5.7 | 45 | 34 | 3.7 |

### Example 18

A reaction was run under the same conditions as in Example 1, except for changing the 1.0 g of 1 mass % W-loaded silica prepared in Preparative Example 1 to 1.0 g of the 1 mass % Mo-loaded beta (pellets) prepared in Preparative Example 21. After the elapse of each time as shown in Table 21, the composition of the reaction gas was analyzed by gas chromatography as in Example 1 and the silane conversion, disilane yield, selectivity for disilane, and space-time yield (STY) for disilane were calculated. The results are given in Table 21.

TABLE 21

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 40.1 | 2.8 | 7 | 34 | 1.8 |
| 200 | 2 | 0.8 | 0.2 | 8 | 1 | 31.6 | 4.5 | 14 | 34 | 2.9 |
| 200 | 3 | 0.8 | 0.2 | 8 | 1 | 20.3 | 4.8 | 24 | 34 | 3.1 |
| 200 | 4 | 0.8 | 0.2 | 8 | 1 | 18.4 | 4.7 | 26 | 34 | 3.0 |
| 200 | 5 | 0.8 | 0.2 | 8 | 1 | 16.8 | 4.9 | 29 | 34 | 3.1 |
| 200 | 6 | 0.8 | 0.2 | 8 | 1 | 16.2 | 4.8 | 30 | 34 | 3.1 |

### Example 19

A reaction was run under the same conditions as in Example 1, except for changing the 1.0 g of 1 mass % W-loaded silica prepared in Preparative Example 1 to 1.0 g of the 1 mass % Mo-loaded mordenite (pellets) prepared in Preparative Example 22. After the elapse of each time as shown in Table 22, the composition of the reaction gas was analyzed by gas chromatography as in Example 1 and the silane conversion, disilane yield, selectivity for disilane, and space-time yield (STY) for disilane were calculated. The results are given in Table 22.

TABLE 22

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 28.3 | 2.4 | 8 | 34 | 1.5 |
| 200 | 2 | 0.8 | 0.2 | 8 | 1 | 16.7 | 3.9 | 23 | 34 | 2.5 |
| 200 | 3 | 0.8 | 0.2 | 8 | 1 | 10.8 | 4.1 | 38 | 34 | 2.6 |
| 200 | 4 | 0.8 | 0.2 | 8 | 1 | 8.9 | 4.4 | 49 | 34 | 2.8 |
| 200 | 5 | 0.8 | 0.2 | 8 | 1 | 9.2 | 4.2 | 46 | 34 | 2.7 |
| 200 | 6 | 0.8 | 0.2 | 8 | 1 | 8.8 | 4.3 | 49 | 34 | 2.8 |

### Example 20

A reaction was run under the same conditions as in Example 1, except for changing the 1.0 g of 1 mass % W-loaded silica prepared in Preparative Example 1 to 1.0 g of the 1 mass % Mo-loaded ferrierite (pellets) prepared in Preparative Example 23. After the elapse of each time as shown in Table 23, the composition of the reaction gas was analyzed by gas chromatography as in Example 1 and the silane conversion, disilane yield, selectivity for disilane, and space-time yield (STY) for disilane were calculated. The results are given in Table 23.

TABLE 23

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 26.2 | 2.3 | 9 | 34 | 1.5 |
| 200 | 2 | 0.8 | 0.2 | 8 | 1 | 16.2 | 3.8 | 23 | 34 | 2.4 |
| 200 | 3 | 0.8 | 0.2 | 8 | 1 | 11.2 | 4.0 | 36 | 34 | 2.6 |
| 200 | 4 | 0.8 | 0.2 | 8 | 1 | 10.0 | 4.2 | 42 | 34 | 2.7 |
| 200 | 5 | 0.8 | 0.2 | 8 | 1 | 9.8 | 4.1 | 42 | 34 | 2.6 |
| 200 | 6 | 0.8 | 0.2 | 8 | 1 | 9.5 | 4.0 | 42 | 34 | 2.6 |

### Example 21

A reaction was run under the same conditions as in Example 1, except for changing the 1.0 g of 1 mass % W-loaded silica prepared in Preparative Example 1 to 1.0 g of the 1 mass % Mo-loaded Y (pellets) prepared in Preparative Example 24. After the elapse of each time as shown in Table 24, the composition of the reaction gas was analyzed by gas chromatography as in Example 1 and the silane conversion, disilane yield, selectivity for disilane, and space-time yield (STY) for disilane were calculated. The results are given in Table 24.

TABLE 24

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 10.3 | 2.1 | 20 | 34 | 1.3 |
| 200 | 2 | 0.8 | 0.2 | 8 | 1 | 8.2 | 1.8 | 22 | 34 | 1.2 |
| 200 | 3 | 0.8 | 0.2 | 8 | 1 | 6.2 | 1.9 | 31 | 34 | 1.2 |
| 200 | 4 | 0.8 | 0.2 | 8 | 1 | 6.6 | 1.8 | 27 | 34 | 1.2 |
| 200 | 5 | 0.8 | 0.2 | 8 | 1 | 6.5 | 2.0 | 31 | 34 | 1.3 |
| 200 | 6 | 0.0 | 0.2 | 8 | 1 | 6.1 | 1.7 | 28 | 34 | 1.1 |

### Example 22

A reaction was run under the same conditions as in Example 1, except for changing the 1.0 g of 1 mass % W-loaded silica prepared in Preparative Example 1 to 1.0 g of the 1 mass % Mo-loaded ZSM-5 (pellets) prepared in Preparative Example 25. After the elapse of each time as shown in Table 25, the composition of the reaction gas was analyzed by gas chromatography as in Example 1 and the silane conversion, disilane yield, selectivity for disilane, and space-time yield (STY) for disilane were calculated. The results are given in Table 25.

TABLE 25

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 31.5 | 4.7 | 15 | 34 | 3.0 |
| 200 | 2 | 0.8 | 0.2 | 8 | 1 | 20.3 | 5.1 | 25 | 34 | 3.3 |
| 200 | 3 | 0.8 | 0.2 | 8 | 1 | 12.3 | 5.8 | 47 | 34 | 3.7 |
| 200 | 4 | 0.8 | 0.2 | 8 | 1 | 12.3 | 6.0 | 49 | 34 | 3.9 |
| 200 | 5 | 0.8 | 0.2 | 8 | 1 | 12.4 | 5.9 | 48 | 34 | 3.8 |
| 200 | 6 | 0.8 | 0.2 | 8 | 1 | 12.5 | 5.8 | 46 | 34 | 3.7 |

### Example 23

A reaction was run under the same conditions as in Example 1, except for changing the 1.0 g of 1 mass % W-loaded silica prepared in Preparative Example 1 to 1.0 g of the 1 mass % Mo-loaded ZSM-5 (pellets) containing 2.4 mass % of Ba prepared in Preparative Example 26. After the elapse of each time as shown in Table 26, the composition of the reaction gas was analyzed by gas chromatography as in Example 1 and the silane conversion, disilane yield, selectivity for disilane, and space-time yield (STY) for disilane were calculated. The results are given in Table 26.

TABLE 26

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 26.3 | 4.1 | 16 | 34 | 2.6 |
| 200 | 2 | 0.8 | 0.2 | 8 | 1 | 19.1 | 5.5 | 29 | 34 | 3.5 |
| 200 | 3 | 0.8 | 0.2 | 8 | 1 | 15.6 | 5.6 | 36 | 34 | 3.6 |
| 200 | 4 | 0.8 | 0.2 | 8 | 1 | 13.7 | 5.5 | 40 | 34 | 3.5 |
| 200 | 5 | 0.8 | 0.2 | 8 | 1 | 13.3 | 5.6 | 42 | 34 | 3.6 |
| 200 | 6 | 0.8 | 0.2 | 8 | 1 | 12.7 | 5.5 | 43 | 34 | 3.5 |

### Example 24

A reaction was run under the same conditions as in Example 1, except for changing the 1.0 g of 1 mass % W-loaded silica prepared in Preparative Example 1 to 1.0 g of the 1 mass % Mn-loaded ZSM-5 (pellets) prepared in Preparative Example 27. After the elapse of each time as shown in Table 27, the composition of the reaction gas was analyzed by gas chromatography as in Example 1 and the silane conversion, disilane yield, selectivity for disilane, and space-time yield (STY) for disilane were calculated. The results are given in Table 27.

TABLE 27

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 12.3 | 2.2 | 18 | 34 | 1.4 |
| 200 | 2 | 0.8 | 0.2 | 8 | 1 | 10.5 | 2.5 | 24 | 34 | 1.6 |
| 200 | 3 | 0.8 | 0.2 | 8 | 1 | 7.8 | 2.7 | 35 | 34 | 1.7 |
| 200 | 4 | 0.8 | 0.2 | 8 | 1 | 6.5 | 2.7 | 42 | 34 | 1.7 |
| 200 | 5 | 0.8 | 0.2 | 8 | 1 | 6.2 | 2.6 | 42 | 34 | 1.7 |
| 200 | 6 | 0.8 | 0.2 | 8 | 1 | 5.8 | 2.5 | 43 | 34 | 1.6 |

### Example 25

A reaction was run under the same conditions as in Example 1, except for changing the 1.0 g of 1 mass % W-loaded silica prepared in Preparative Example 1 to 1.0 g of the 0.8 mass % V-loaded ZSM-5 (pellets) prepared in Preparative Example 28. After the elapse of each time as shown in Table 28, the composition of the reaction gas was analyzed by gas chromatography as in Example 1 and the silane conversion, disilane yield, selectivity for disilane, and space-time yield (STY) for disilane were calculated. The results are given in Table 28.

TABLE 28

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 30.8 | 4.5 | 15 | 34 | 2.9 |
| 200 | 2 | 0.8 | 0.2 | 8 | 1 | 27.6 | 5.7 | 21 | 34 | 3.7 |
| 200 | 3 | 0.8 | 0.2 | 8 | 1 | 22.3 | 5.7 | 26 | 34 | 3.7 |
| 200 | 4 | 0.8 | 0.2 | 8 | 1 | 18.7 | 5.7 | 30 | 34 | 3.7 |
| 200 | 5 | 0.8 | 0.2 | 8 | 1 | 17.6 | 5.8 | 33 | 34 | 3.7 |
| 200 | 6 | 0.8 | 0.2 | 8 | 1 | 17.7 | 5.7 | 32 | 34 | 3.7 |

### Example 26

A reaction was run under the same conditions as in Example 1, except for changing the 1.0 g of 1 mass % W-loaded silica prepared in Preparative Example 1 to 1.0 g of the 1 mass % Nb-loaded ZSM-5 (pellets) prepared in Preparative Example 29. After the elapse of each time as shown in Table 29, the composition of the reaction gas was analyzed by gas chromatography as in Example 1 and the silane conversion, disilane yield, selectivity for disilane, and space-time yield (STY) for disilane were calculated. The results are given in Table 29.

TABLE 29

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 10.8 | 2.1 | 19 | 34 | 1.3 |
| 200 | 2 | 0.8 | 0.2 | 8 | 1 | 8.7 | 2.2 | 25 | 34 | 1.4 |
| 200 | 3 | 0.8 | 0.2 | 8 | 1 | 5.8 | 2.5 | 43 | 34 | 1.6 |
| 200 | 4 | 0.8 | 0.2 | 8 | 1 | 5.7 | 2.5 | 44 | 34 | 1.6 |
| 200 | 5 | 0.8 | 0.2 | 8 | 1 | 5.5 | 2.4 | 44 | 34 | 1.5 |
| 200 | 6 | 0.8 | 0.2 | 8 | 1 | 5.2 | 2.2 | 42 | 34 | 1.4 |

### Example 27

A reaction was run under the same conditions as in Example 1, except for changing the 1.0 g of 1 mass % W-loaded silica prepared in Preparative Example 1 to 1.0 g of the 1 mass % Mo-loaded ZSM-5 (pellets) prepared in Preparative Example 30 using molybdenum oxide. After the elapse of each time as shown in Table 30, the composition of the reaction gas was analyzed by gas chromatography as in Example 1 and the silane conversion, disilane yield, selectivity for disilane, and space-time yield (STY) for disilane were calculated. The results are given in Table 30.

TABLE 30

| Reaction | | | | | | | | | Contact | |
|---|---|---|---|---|---|---|---|---|---|---|
| temperature | Time | Flow rate [mL/minute] | | | | Silane | Disilane | Selectivity | (residence) | STY |
| [° C.] | [h] | Silane | Ar | He | H₂ | conversion [%] | yield [%] | tor disilane [%] | [second] | [g/kgh] |
| 200 | 1 | 0.8 | 0.2 | 8 | 1 | 24.3 | 4.5 | 19 | 34 | 2.9 |
| 200 | 2 | 0.8 | 0.2 | 8 | 1 | 21.3 | 5.7 | 27 | 34 | 3.7 |
| 200 | 3 | 0.8 | 0.2 | 8 | 1 | 16.7 | 5.8 | 35 | 34 | 3.7 |
| 200 | 4 | 0.8 | 0.2 | 8 | 1 | 14.9 | 5.7 | 38 | 34 | 3.7 |
| 200 | 5 | 0.8 | 0.2 | 8 | 1 | 14.1 | 5.8 | 41 | 34 | 3.7 |
| 200 | 6 | 0.8 | 0.2 | 8 | 1 | 13.8 | 5.6 | 41 | 34 | 3.6 |

### Example 28

A reaction was run under the same conditions as in Example 1, except for changing the 1.0 g of 1 mass % W-loaded silica prepared in Preparative Example 1 to 1.0 g of the 1 mass % Cr-loaded ZSM-22 zeolite powder prepared in Preparative Example 31. After the elapse of each time as shown in Table 31, the composition of the reaction gas was analyzed by gas chromatography as in Example 1 and the silane conversion, disilane yield, selectivity for disilane, and space-time yield (STY) for disilane were calculated. The results are given in Table 31.

TABLE 31

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 200 | 1 | 0.8 | 0.2 | 8 | 1 | 24.3 | 4.7 | 19 | 34 | 3.0 |
| 200 | 2 | 0.8 | 0.2 | 8 | 1 | 22.3 | 6.1 | 27 | 34 | 3.9 |
| 200 | 3 | 0.8 | 0.2 | 8 | 1 | 15.8 | 5.5 | 35 | 34 | 3.5 |
| 200 | 4 | 0.8 | 0.2 | 8 | 1 | 14.2 | 5.6 | 39 | 34 | 3.6 |
| 200 | 5 | 0.8 | 0.2 | 8 | 1 | 14.0 | 5.5 | 39 | 34 | 3.5 |
| 200 | 6 | 0.8 | 0.2 | 8 | 1 | 13.9 | 5.6 | 40 | 34 | 3.6 |

contact (residence) time (second)

### <Comparative Example 4> (Absence of Catalyst)

Without introducing a catalyst into the reaction tube, the air was removed from the reaction tube using a vacuum pump and substitution with helium gas was then carried out. The helium gas was caused to flow through at a rate of 20 mL/minute and the temperature was raised to 350° C., after which throughflow was performed for 1 hour. Then, an argon/silane mixed gas (Ar: 20%, SiH₄: 80% (volume ratio)) at 2 mL/minute, hydrogen gas at 2 mL/minute, and helium gas at 16 mL/minute were mixed in a gas mixer and caused to flow through. After 5 minutes, the argon/silane mixed gas was changed to 1 mL/minute, the hydrogen gas was changed to 1 mL/minute, and the helium gas was changed to 8 mL/minute. After the elapse of 1 hour as shown in Table 32, the composition of the reaction gas was analyzed by gas chromatography as in Example 1 and the silane conversion, disilane yield, selectivity for disilane, and space-time yield (STY) for disilane were calculated. The results are given in Table 32.

TABLE 32

| | | | | | | | | | Contact | |
|---|---|---|---|---|---|---|---|---|---|---|
| Reaction | | | | | | | | | (residence) | |
| temperature | Time | Flow rate [mL/minute] | | | | Silane | Disilane | Selectivity | time | STY |
| [° C.] | [h] | Silane | Ar | He | H₂ | conversion [%] | yield [%] | for disilane [%] | [second] | [g/kgh] |
| 350 | 1 | 0.8 | 0.2 | 8 | 1 | 0.0 | 0.0 | — | — | — |

As is shown by a comparison of Example 1 with Comparative Example 1, Example 2 with Comparative Example 2, and Example 3 with Comparative Example 3, the use of a catalyst containing a Periodic Table group 3 transition element, etc., provides a higher disilane yield than the use of a catalyst not containing a Periodic Table group 3 transition element, etc. In addition, as shown by a comparison of Example 1 (200° C. reaction temperature) with Comparative Example 4 (350° C. reaction temperature), the use of a catalyst containing a Periodic Table group 3 transition element, etc., provides disilane at high yields at temperatures lower than in the absence of catalyst.

Moreover, a comparison of Example 1 and Example 2 shows that a higher disilane yield is obtained by using zeolite as the support rather than silica. A comparison of Example 2 with Example 3 shows that, among the zeolites used as the support, a higher disilane yield is obtained by the use of zeolite having a pore diameter in the specific range.

Example 3, Example 4, and Example 5 demonstrate that a particularly high disilane yield is obtained using zeolite containing a group 5 transition element or a group 6 transition element. A comparison of Example 7, Example 8, Example 9, and Example 10 with Example 3 and Example 4 demonstrates that the use of zeolite containing a Periodic Table group 1 main group element, etc., and loaded with a Periodic Table group 3 transition element, etc., provides a high disilane yield and a high selectivity for disilane after 1 hour and demonstrates that the incorporation of a Periodic Table group 1 main group element, etc., accrues an effect in particular in the early stage of the reaction.

A comparison of Example 7 with Example 11 demonstrates that a value of “(AM/Al)/(1-TM/Al)” of 0.49 provides a higher disilane yield than a value of 1.0.

Example 12 is an example that uses a ZSM-5 having a silica/alumina ratio of 40, while Example 28 is an example that uses a ZSM-22 having a silica/alumina ratio of 65 to 80.

Examples 13 and 14 are examples of Ba-containing Mo-loaded catalysts that were prepared by different processes using ZSM-5 having a silica/alumina ratio of 40.

Examples 15 to 27 demonstrate that the reaction can be unproblematically carried out even using zeolite that has been molded into pellets.

The present invention is not limited to the preceding embodiments and examples and various modifications are possible, but these are of course also encompassed by the scope of the present invention. This application is based on Japanese Patent Application No. 2016-026827 filed Feb. 16, 2016 and Japanese Patent Application No. 2016-225853 filed Nov. 21, 2016, the contents of which are incorporated herein by reference.

### INDUSTRIAL APPLICABILITY

The disilane provided by the oligosilane production method of the present invention can be expected to be used as a gas for the production of silicon for semiconductors.

### REFERENCE SIGNS LIST

1 Tetrahydrosilane gas (SiH₄) cylinder (20% argon mixture)
2 Hydrogen gas (H₂) cylinder
3 Helium gas (He) cylinder
4 Emergency shutoff valve (gas inspection shutoff valve)
Pressure reduction valve
6 Mass flow controller (MFC)
7 Pressure gauge
8 Gas mixer
9 Reaction tube
Filter
11 Rotary pump
12 Gas chromatograph
13 Abatement apparatus

1. A method for producing an oligosilane, comprising a reaction step of producing an oligosilane by dehydrogenative coupling of hydrosilane, wherein
the reaction step is carried out in the presence of a catalyst containing at least one transition element selected from the group consisting of Periodic Table group 3 transition elements, group 4 transition elements, group 5 transition elements, group 6 transition elements, and group 7 transition elements.

2. The method for producing an oligosilane according to claim 1, wherein the catalyst is a heterogeneous catalyst containing a support and contains the transition element on the surface and/or in the interior of the support.

3. The method for producing an oligosilane according to claim 2, wherein the support is at least one selected from the group consisting of silica, alumina, titania, and zeolite.

4. The method for producing an oligosilane according to claim 3, wherein the zeolite has pores with a minor diameter of at least 0.43 nm and a major diameter of not more than 0.69 nm.

5. The method for producing an oligosilane according to claim 3, wherein the support is a spherical or cylindrical molding, of an alumina-containing powder as a binder and a zeolite having pores with a minor diameter of at least 0.43 nm and a major diameter of not more than 0.69 nm, and has an alumina content (per 100 mass parts of the support not containing the alumina or transition element) of at least 10 mass parts and not more than 30 mass parts.

6. The method for producing an oligosilane according to claim 1, wherein the transition element is at least one transition element selected from the group consisting of titanium, vanadium, niobium, chromium, molybdenum, tungsten, and manganese.

7. The method for producing an oligosilane according to claim 6, wherein the transition element is at least one transition element selected from the group consisting of molybdenum and tungsten.

8. The method for producing an oligosilane according to claim 3, wherein the catalyst contains zeolite as a support and further comprises, on the surface and/or in the interior of the zeolite, at least one main group element selected from the group consisting of Periodic Table group 1 main group elements and group 2 main group elements.

9. The method for producing an oligosilane according to claim 8, wherein the overall transition element content and the overall main group element content (with respect to the zeolite in a state containing the transition element and main group element) are amounts that satisfy the condition in the following formula (1):
$$[ Math . 1 ]$$
$$0.1 ≦ \frac{AM \text{/} A 1}{1 - TM \text{/} A 1} ≦ 0.9 \qquad ( 1 )$$
(In formula (1), AM/Al represents an atomic ratio obtained by dividing the total number of main group element atoms contained in the zeolite by the number of aluminum atoms contained in the zeolite, and TM/Al represents an atomic ratio obtained by dividing the total number of transition element atoms contained in the zeolite by the number of aluminum atoms contained in the zeolite.).

10. The method for producing an oligosilane according to claim 8, wherein the overall main group element content (with respect to the mass of the zeolite in a state containing the transition element and main group element) is at least 2.1 mass % and not more than 10 mass %.

11. A method for producing a catalyst for dehydrogenative coupling that produces an oligosilane by dehydrogenative coupling of hydrosilane, the catalyst containing, on the surface or in the interior of a support, at least one transition element selected from the group consisting of Periodic Table group 3 transition elements, group 4 transition elements, group 5 transition elements, group 6 transition elements, and group 7 transition elements,
the method comprising:
a support preparation step of preparing a support;
a transition element introduction step of loading the support prepared in the support preparation step with at least one transition element selected from the group consisting of Periodic Table group 3 transition elements, group 4 transition elements, group 5 transition elements, group 6 transition elements, and group 7 transition elements; and
a transition element heating step of heating a precursor that has gone through the transition element introduction step.

12. The method for producing a catalyst according to claim 11, wherein
the catalyst further comprises at least one main group element selected from the group consisting of Periodic Table group 1 main group elements and group 2 main group elements,
the method further comprising:
a main group element introduction step of loading the support with at least one main group element selected from the group consisting of Periodic Table group 1 main group elements and group 2 main group elements.

13. The method for producing a catalyst according to claim 12, comprising:
a main group element heating step of heating a precursor that has gone through the main group element introduction step.

14. The method for producing a catalyst according to claim 13, wherein the main group element introduction step, main group element heating step, transition element introduction step, and transition element heating step are carried out in this order.

15. The method for producing a catalyst according to claim 13, wherein the transition element introduction step, transition element heating step, main group element introduction step, and main group element heating step are carried out in this order.

16. The method for producing a catalyst according to claim 11, wherein the support is at least one selected from the group consisting of silica, alumina, titania, and zeolite.

17. The method for producing a catalyst according to claim 16, wherein the zeolite has pores with a minor diameter of at least 0.43 nm and a major diameter of not more than 0.69 nm.

18. The method for producing a catalyst according to claim 16, wherein the support is a spherical or cylindrical molding of an alumina-containing powder as a binder and a zeolite having pores with a minor diameter of at least 0.43 nm and a major diameter of not more than 0.69 nm, and has an alumina content (per 100 mass parts of the support not containing the alumina or transition element) of at least 10 mass parts and not more than 30 mass parts.

19. The method for producing a catalyst according to claim 11, wherein the transition element is at least one transition element selected from the group consisting of titanium, vanadium, niobium, chromium, molybdenum, tungsten, and manganese.
